(19) United States
(12) Patent Application Publication
(10) Pub. No.: US 2005/0052740 A1
(43) Pub. Date: Mar. 10, 2005

(54) Method of phase shift adjustment of a polarization beam splitter film

(75) Inventors: Tomokazu Taguchi, Osaka (JP); Takuji Hatano, Osaka (JP); Kazuyuki Nishi, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 10/935,844

(22) Filed: Sep. 8, 2004

(30) Foreign Application Priority Data
Sep. 9, 2003 (JP) 2003-316612

(51) Int. Cl. G02B 5/30

(52) U.S. Cl. 359/487; 359/485

(57) ABSTRACT

According to a method of adjusting the phase shift of s-polarized light reflected from a polarization beam splitter film having a multiple-layer construction, in a desired range of incidence angles and in a desired range of wavelengths, when the reflection-induced phase shift of s-polarized light is not linear with respect to the incidence angle thereof, the layers are arranged in reverse order.

This application is based on Japanese Patent Application No. 2003-316612 filed on Sep. 9, 2003, the contents of which are hereby incorporated by reference.

### BACKGROUND OF THE INVENTION

1. Field of the Invention

The present invention relates to a method of phase shift adjustment of a polarization beam splitter film. More particularly, the present invention relates to a polarization beam splitter film having optical characteristics suitable, for example, for the optical system of an optical pickup for a blue laser, and to a method of phase shift adjustment thereof.

2. Description of Related Art

Many optical systems designed for optical pickups use a polarization beam splitter film that is capable of achieving polarization separation. However, conventionally known polarization beam splitter films exhibit high dependence on incidence angle, and this makes it difficult to achieve, by using them, satisfactory polarization separation with incident light having a large divergence angle, such as blue laser light. Thus, there have been demands for polarization beam splitter films having polarization separation characteristics that exhibit low dependence on incidence angle. In response, polarization beam splitter films that offer predetermined polarization separation characteristics for so wide a range of angles as to be able to cope with incident light having a divergence angle of ±5° or more have been proposed in Patent Publications 1 and 2 listed below.
Patent Publication 1: Japanese Patent Application Laid-Open No. H8-146218
Patent Publication 2: Japanese Patent Application Laid-Open No. H9-184916

However, with the polarization beam splitter films disclosed in Patent Publications 1 and 2, it is only possible to reduce the incidence-angle dependence of s-polarized light to about 20% in terms of transmissivity, and thus it is impossible to obtain satisfactory polarization separation characteristics. Accordingly, using these polarization beam splitter films in the optical system of an optical pickup for a blue laser or the like results in problems such as an undue lowering of the amount of light.

Moreover, with conventionally known polarization beam splitter films, when s-polarized light is reflected therefrom, the phase thereof is shifted, causing irregular variations in the phase shift of s-polarized light depending on the incidence angle thereof. This lowers the wavefront accuracy of s-polarized light. Blue lasers have, on one hand, problems such as low oscillation stability, and, on the other hand, require high precision in the optical systems of the optical pickups that incorporate them. Thus, in the presence of irregular variations in the phase shift of s-polarized light depending on the incidence angle thereof, the signal receiver, under the influence of the lowering of the wavefront accuracy, causes various problems. Patent Publication 2 discloses a polarization beam splitter film in which a phase adjustment film having a large film thickness is used with a view to diminishing the incidence-angle dependence of the phase difference between s- and p-polarized light that is produced when it is transmitted or reflected. Even with this polarization beam splitter film, it is not possible to prevent irregular variations in the phase shift of s-polarized light depending on the incidence angle thereof.

### SUMMARY OF THE INVENTION

In view of the conventionally experienced inconveniences mentioned above, it is an object of the present invention to provide a polarization beam splitter film that, while maintaining good polarization separation characteristics exhibiting low dependence on incidence angle, can reflect s-polarized light with high wavefront accuracy, and to provide a method of adjusting the phase shift of such a polarization beam splitter film for easy fabrication thereof.

To achieve the above objects, in one aspect of the present invention, a method of adjusting the phase shift of s-polarized light reflected from a polarization beam splitter film having a multiple-layer construction is characterized in that, in a desired range of incidence angles and in a desired range of wavelengths, when the reflection-induced phase shift of the s-polarized light is not linear with respect to the incidence angle thereof, the layers are arranged in reverse order.

In another aspect of the present invention, a polarization beam splitter film having a multiple-layer construction is characterized in that, in a desired range of incidence angles and in a desired range of wavelengths, the reflection-induced phase shift of s-polarized light varies linearly with respect to the variation of the incidence angle thereof, whereas, when the multiple-layer construction has the layers thereof arranged in reverse order, the reflection-induced phase shift of the s-polarized light does not vary linearly with respect to the variation of the incidence angle thereof.

In another aspect of the present invention, a polarization beam splitter is provided with a first substrate that is transparent and a polarization beam splitter film formed on the first substrate, and is characterized in that, when light in a desired range of wavelengths is incident on the polarization beam splitter film from a first direction in a desired range of incidence angles, the deviation of the reflection-induced phase shift of s-polarized light from the phase shift curve expressed as a linear function determined by the phase shifts observed at the minimum and maximum incidence angles is within ±50° all over the desired range of incidence angles, and, when the light is incident on the polarization beam splitter film from a second direction opposite to the first direction, the reflection-induced phase shift of the s-polarized light from the phase shift curve is outside ±50° all over the desired range of incidence angles.

In another aspect of the present invention, a polarization beam splitter is provided with a first substrate that is transparent and a polarization beam splitter film formed on the first substrate, and is characterized in that, when light in a desired range of wavelengths is incident on the polarization beam splitter film from a first direction in a desired range of incidence angles, the deviation of the reflection-induced phase shift of s-polarized light from the phase shift curve expressed as a linear function determined by the phase shifts observed at the minimum and maximum incidence angles is within ±20° all over the desired range of incidence angles, and, when the light is incident on the polarization beam splitter film from a second direction opposite to the first direction, the reflection-induced phase shift of the s-polarized light from the phase shift curve is outside ±20° all over the desired range of incidence angles.

In another aspect of the present invention, a polarization beam splitter is provided with a first substrate that is transparent and a polarization beam splitter film formed on the first substrate, and is characterized in that, when light in a desired range of wavelengths is incident on the polarization beam splitter film from a first direction in a desired range of incidence angles, the deviation of the reflection-induced phase shift of s-polarized light from the phase shift curve expressed as a linear function determined by the phase shifts observed at the minimum and maximum incidence angles is within ±10° all over the desired range of incidence angles, and, when the light is incident on the polarization beam splitter film from a second direction opposite to the first direction, the reflection-induced phase shift of the s-polarized light from the phase shift curve is outside ±10° all over the desired range of incidence angles.

By a method of adjusting the phase shift of a polarization beam splitter film according to the present invention, it is possible to easily make the reflection-induced phase shift of s-polarized light linear with respect to the variation of the incidence angle thereof. On the other hand, in a polarization beam splitter film according to the present invention, the reflection-induced phase shift of s-polarized light varies linearly with respect to the variation of the incidence angle. This makes it possible to reflect s-polarized light with high wavefront accuracy while maintaining satisfactory polarization separation characteristics exhibiting low incidence-angle dependence. By using a polarization beam splitter film according to the present invention or a transparent optical component provided therewith in an optical system that receives incident light having a large divergence angle but that nevertheless requires satisfactory p-/s-polarization separation characteristics (for example, the optical system of an optical pickup using a blue laser), it is possible to dramatically enhance the wavefront accuracy of the light reflected from the polarization beam splitter film, and thereby to obtain excellent optical performance and other benefits.

### BRIEF DESCRIPTION OF THE DRAWINGS

FIG. 1 is a flow chart showing a method of adjusting the phase shift of a polarization beam splitter film according to the invention;

FIG. 2 is a graph showing the polarization separation characteristics as observed in the range of incidence angles from 40° to 50° in the first PBS;

FIG. 3 is a graph showing the reflection-induced phase shift of s-polarized light as observed in the range of incidence angles from 40° to 50° in the first PBS;

FIG. 4 is a graph showing the electric field intensity distribution of s-polarized light as observed at an incidence angle of 40° in the first PBS;

FIG. 5 is a graph showing the electric field intensity distribution of s-polarized light as observed at an incidence angle of 41° in the first PBS;

FIG. 6 is a graph showing the electric field intensity distribution of s-polarized light. as observed at an incidence angle of 42° in the first PBS;

FIG. 7 is a graph showing the electric field intensity distribution of s-polarized light as observed at an incidence angle of 43° in the first PBS;

FIG. 8 is a graph showing the electric field intensity distribution of s-polarized light as observed at an incidence angle of 44° in the first PBS;

FIG. 9 is a graph showing the electric field intensity distribution of s-polarized light as observed at an incidence angle of 45° in the first PBS;

FIG. 10 is a graph showing the electric field intensity distribution of s-polarized light as observed at an incidence angle of 46° in the first PBS;

FIG. 11 is a graph showing the electric field intensity distribution of s-polarized light as observed at an incidence angle of 47° in the first PBS;

FIG. 12 is a graph showing the electric field intensity distribution of s-polarized light as observed at an incidence angle of 48° in the first PBS;

FIG. 13 is a graph showing the electric field intensity distribution of s-polarized light as observed at an incidence angle of 49° in the first PBS;

FIG. 14 is a graph showing the electric field intensity distribution of s-polarized light as observed at an incidence angle of 50° in the first PBS;

FIG. 15 is a graph showing the electric field intensity distribution of s-polarized light as observed at an incidence angle of 44.3° in the first PBS;

FIG. 16 is a graph showing the electric field intensity distribution of s-polarized light as observed at an incidence angle of 46.3° in the first PBS;

FIG. 17 is a graph showing the reflection-induced phase shift of s-polarized light as observed in the range of incidence angles from 40° to 50° in the second PBS;

FIG. 18 is a graph showing the polarization separation characteristics as observed in the range of incidence angles from 40° to 50° in the second PBS;

FIG. 19 is a graph showing the polarization separation characteristics as observed in the range of incidence angles from 40° to 50° in the third PBS;

FIG. 20 is a graph showing the reflection-induced phase shift of s-polarized light as observed in the range of incidence angles from 40° to 50° in the third PBS;

FIG. 21 is a graph showing the polarization separation characteristics as observed in the range of incidence angles from 40° to 50° in the first and third PBSs;

FIG. 22 is a graph showing the polarization separation characteristics plotted at 2 nm increments as observed in the range of wavelengths of 405±5 nm in the first PBS;

FIG. 23 is a graph showing the polarization separation characteristics plotted at 2 nm increments as observed in the range of wavelengths of 405±5 nm in the third PBS;

FIG. 24 is a graph showing the polarization separation characteristics as observed in the range of incidence angles from 40° to 50° in the first and fourth PBSs;

FIG. 25 is a graph showing the polarization separation characteristics plotted at 2 nm increments as observed in the range of wavelengths of 405±5 nm in the fourth PBS;

FIG. 26 is a graph showing the reflection-induced phase shift of s-polarized light as observed in the range of incidence angles from 40° to 50° in the fourth PBS;

FIG. 27 is a graph showing the electric field intensity distribution of s-polarized light as observed at an incidence angle of 40° in the fourth PBS;

FIG. 28 is a graph showing the electric field intensity distribution of s-polarized light as observed at an incidence angle of 41° in the fourth PBS;

FIG. 29 is a graph showing the electric field intensity distribution of s-polarized light as observed at an incidence angle of 42° in the fourth PBS;

FIG. 30 is a graph showing the electric field intensity distribution of s-polarized light as observed at an incidence angle of 43° in the fourth PBS;

FIG. 31 is a graph showing the electric field intensity distribution of s-polarized light as observed at an incidence angle of 44° in the fourth PBS;

FIG. 32 is a graph showing the electric field intensity distribution of s-polarized light as observed at an incidence angle of 45° in the fourth PBS;

FIG. 33 is a graph showing the electric field intensity distribution of s-polarized light as observed at an incidence angle of 46° in the fourth PBS;

FIG. 34 is a graph showing the electric field intensity distribution of s-polarized light as observed at an incidence angle of 47° in the fourth PBS;

FIG. 35 is a graph showing the electric field intensity distribution of s-polarized light as observed at an incidence angle of 48° in the fourth PBS;

FIG. 36 is a graph showing the electric field intensity distribution of s-polarized light as observed at an incidence angle of 49° in the fourth PBS;

FIG. 37 is a graph showing the electric field intensity distribution of s-polarized light as observed at an incidence angle of 50° in the fourth PBS;

### DETAILED DESCRIPTION OF PREFERRED EMBODIMENTS

Hereinafter, polarization beam splitter films according to the present invention, a method for adjusting the phase shift hereof, and other features of the present invention will be described with reference to the drawings. In the following description, the polarization separation splitters (PBSs) presented are all so constructed that first a polarization beam splitter film is formed on one glass substrate and then the loose end of the polarization beam splitter film is bonded to another glass substrate with an adhesive layer interposed in between so that the polarization beam splitter film is sandwiched between the two glass substrates. It should be understood, however, that this is not intended to restrict the construction of those PBSs in any way. For example, instead of forming a polarization beam splitter film between substrates, it is also possible to form a polarization beam splitter film on a transparent substrate and then coat the polarization beam splitter film with a protective film. As necessary, substrates made of a material other than glass (for example, plastic or ceramic substrates) may be used.

Tables 1 and 2 show the multiple-layer construction of a first PBS (QWOT=4·n·d/λ0, where d represents the physical film thickness; n represents the refractive index; and λ0 represents the design wavelength). In the polarization beam splitter film of the first PBS, on a glass substrate M (with a refractive index of 1.64) disposed on the light-entrance side, there are laid a total of 44 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between.

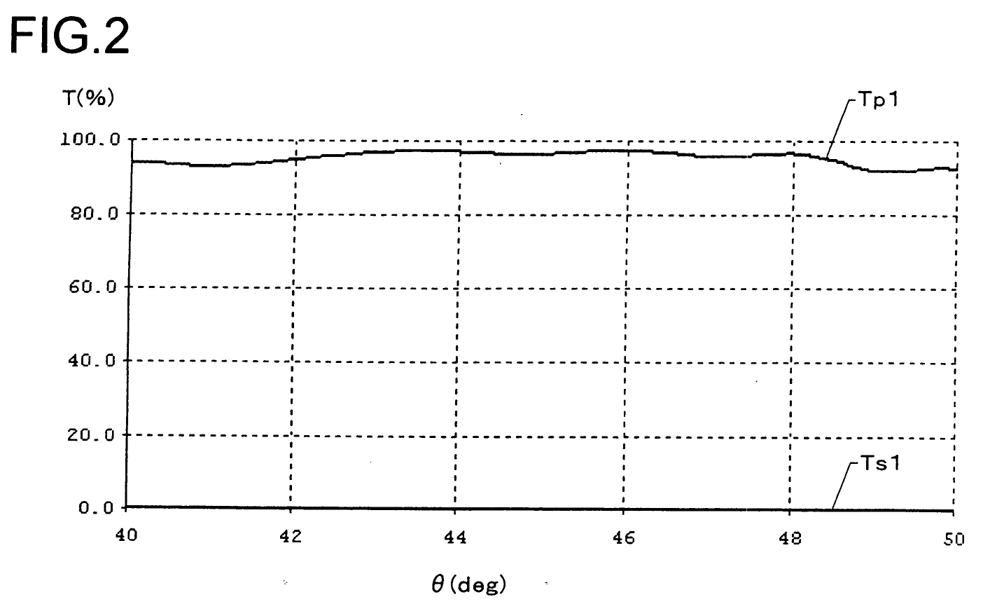

FIG. 2 shows the polarization separation characteristics of the first PBS in terms of transmissivity T(%). FIG. 2 shows the transmissivity Tp1 of p-polarized light and the transmissivity Ts1 of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 2, the first PBS has polarization separation characteristics exhibiting low incidence-angle dependence. This makes the first PBS suitable as a polarization beam splitter for a blue laser. It should be noted that, here, a blue laser denotes, for example, a laser operating at a wavelength from 390 nm to 420 nm.

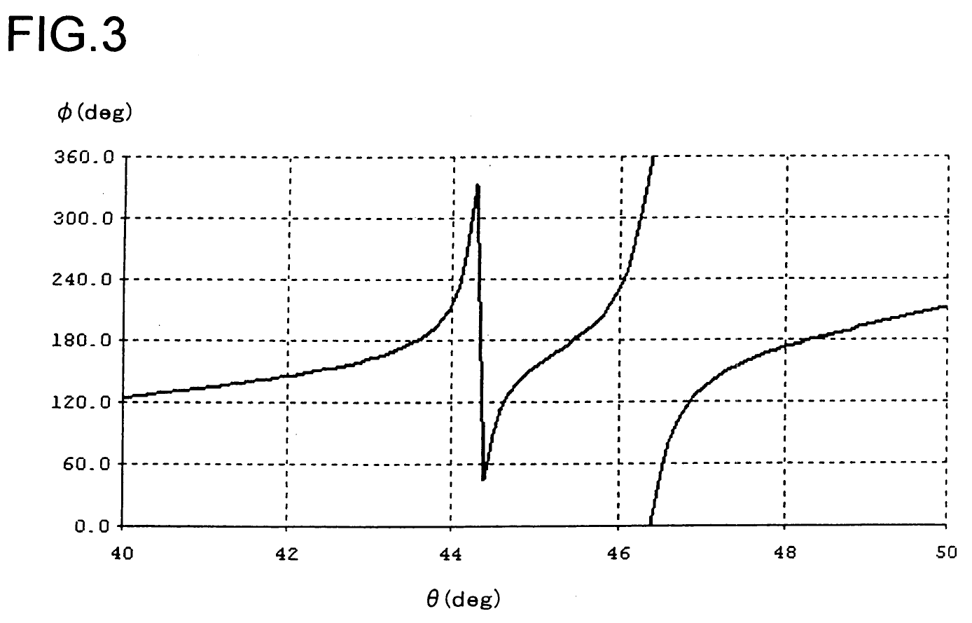

FIG. 3 shows the reflection-induced phase shift φ(°) of s-polarized light (with a wavelength λ of 405 nm) as observed in the range of incidence angles θ from 40° to 50° in the first PBS. As will be understood from FIG. 3, the reflection-induced phase shift φ of s-polarized light does not vary linearly with respect to the variation of the incidence angle. On the contrary, the curve representing the phase shift φ exhibits inflection points and singular points around incidence angles θ from 44° to 47°. Among these, the inflection points around incidence angles θ of 45.5° and 46.5° describe comparatively smooth curves, and can thus be controlled to be comparatively linear by exploiting film thickness adjustment and automatic designing; by contrast, the two spikes (i.e., singular points) around incidence angles θ from 44° to 45° cannot be removed in that way.

In the multiple-layer construction of the first PBS, when divergent light in the range of incidence angles θ of 45°±5° is incident, irregular variations appearing in the phase shift of s-polarized light lowers the wavefront accuracy of s-polarized light. To overcome this problem, when a polarization beam splitter film having a multiple-layer construction is fabricated, it is necessary to adjust the phase shift of the s-polarized light reflected from the polarization beam splitter film. Incidentally, the s-polarized light reflected from a polarization beam splitter film is subjected to interference-based evaluation of the wavefront thereof using a reference plate, whereby a bend is observed in the image of the transmitted wavefront of the s-polarized light transmitted through the reference plate, permitting the degradation of the transmitted wavefront accuracy to be confirmed.

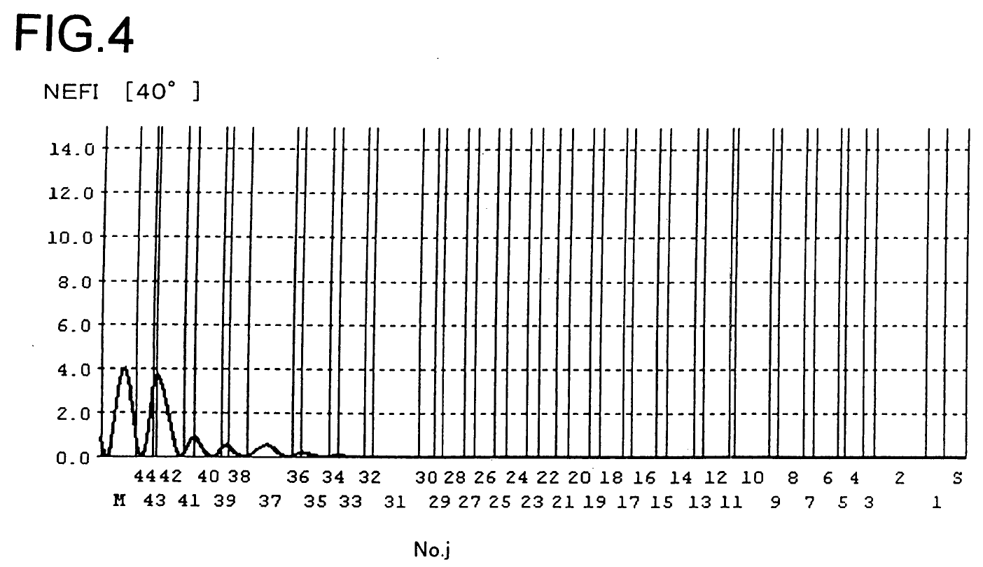

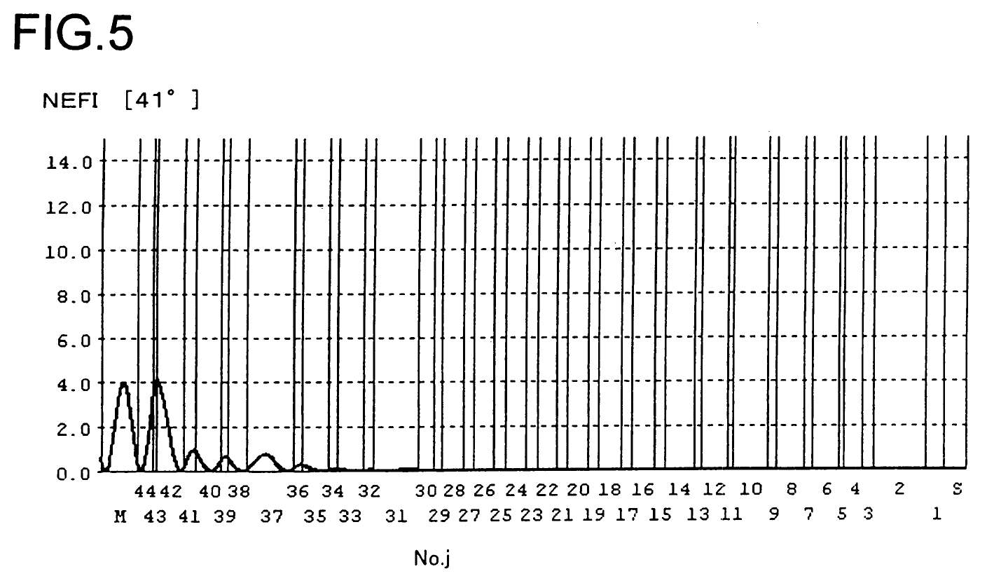

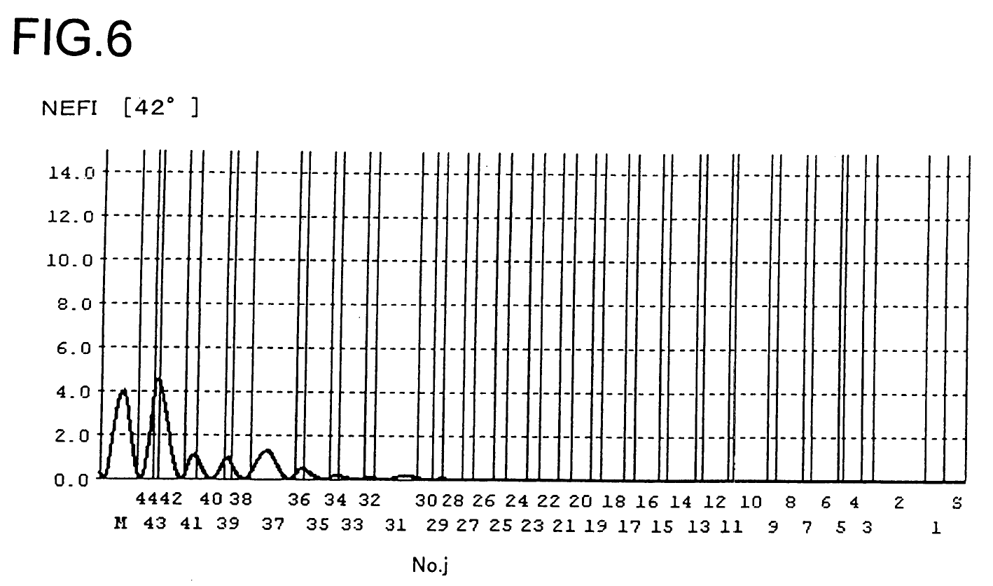

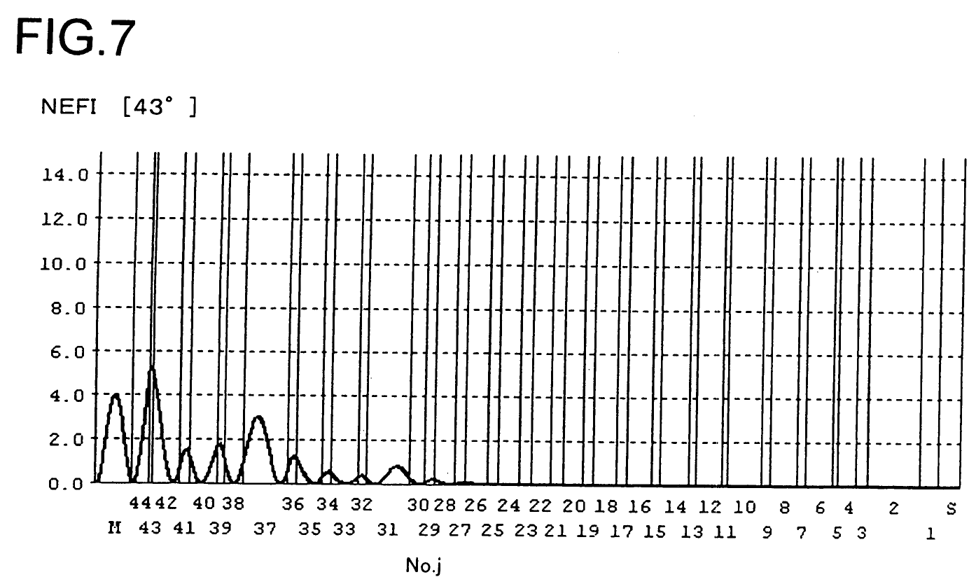

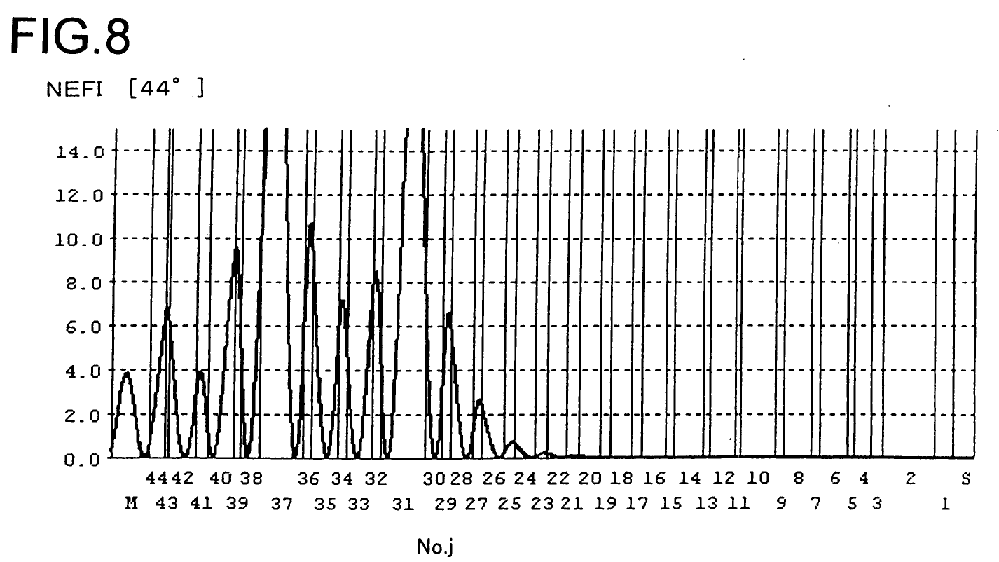

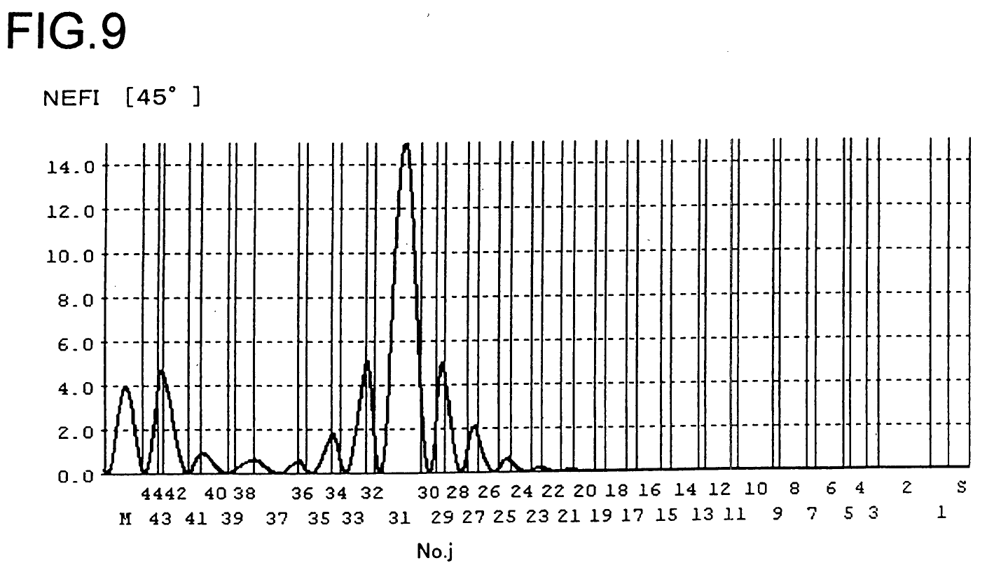

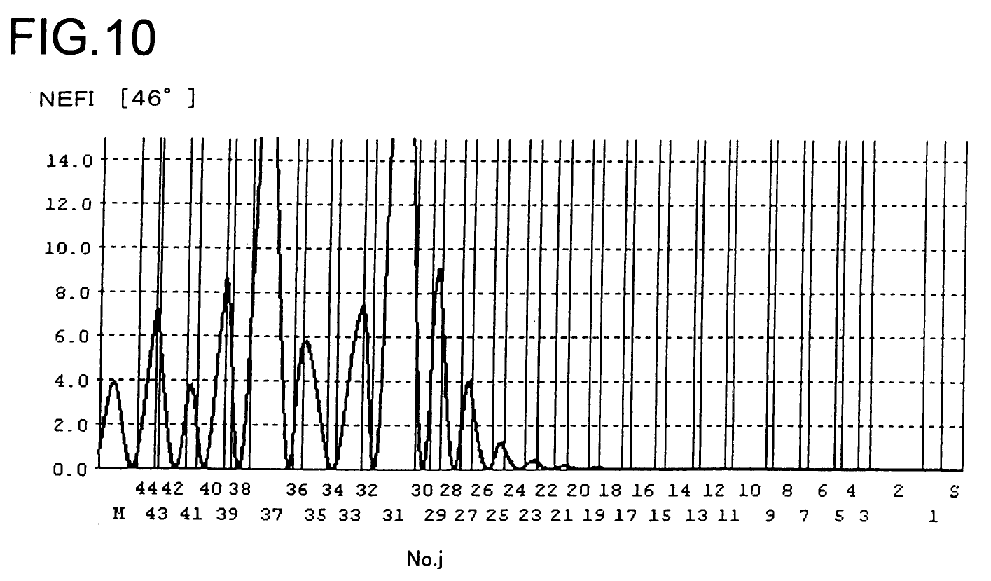

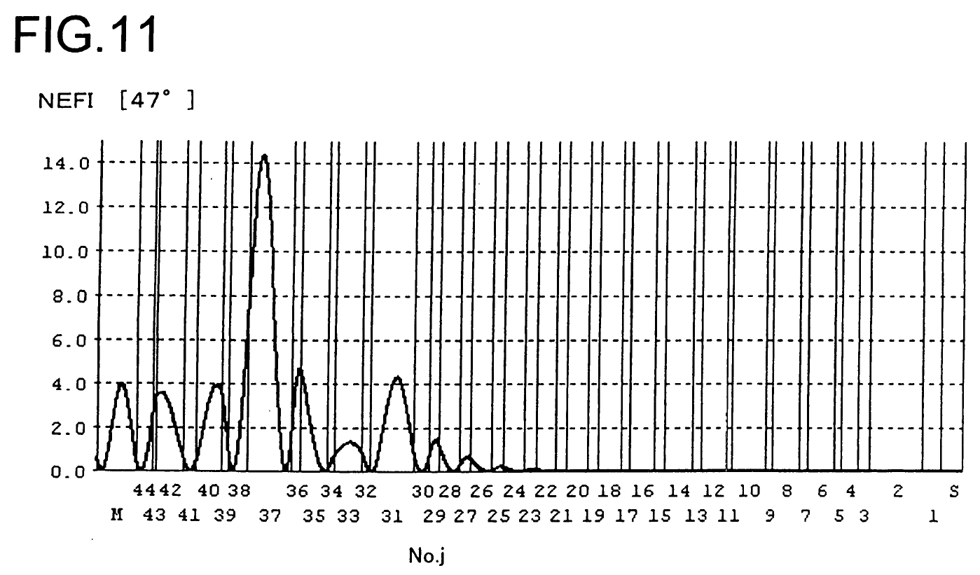

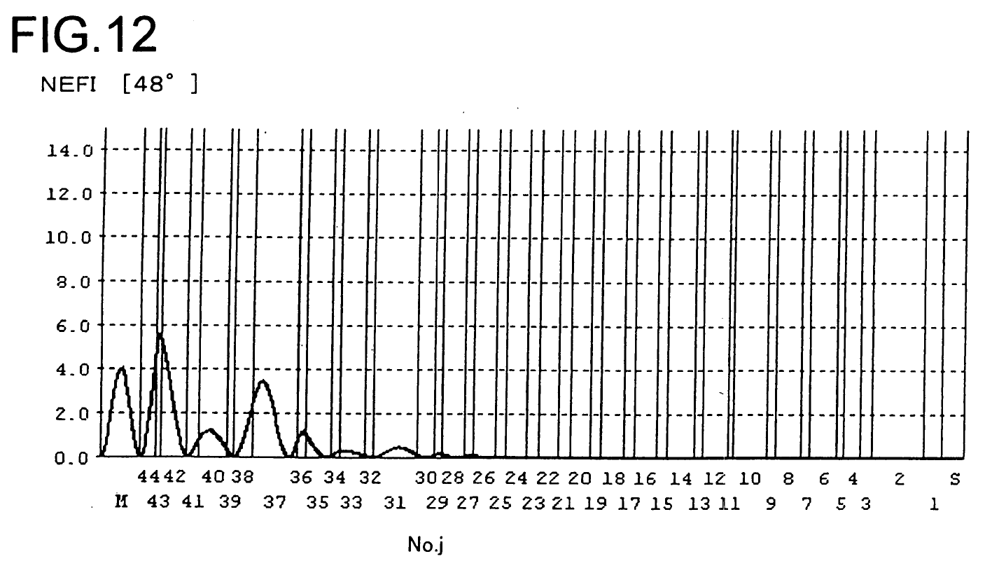

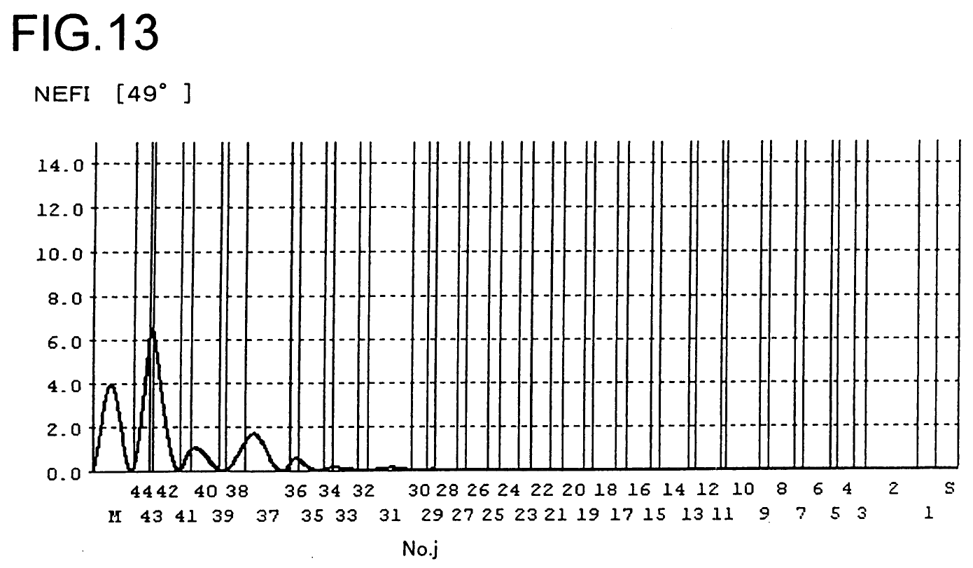

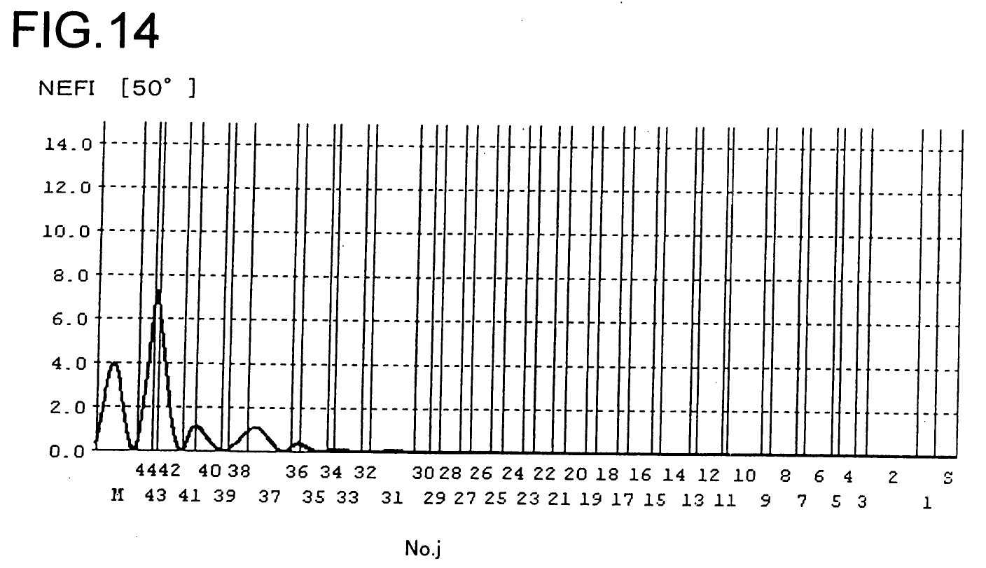

FIGS. 4 to 14 show the electric field intensity distribution of s-polarized light (with a wavelength λ of 405 nm) as observed at each integer angle in the range of incidence angles θ from 40° to 50° in the first PBS. In the graphs of FIGS. 4 to 14, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 4 to 14, the vertical axis represents the normalized electric field intensity (NEFI) of the layers. As will be understood from FIGS. 8 to 11, at incidence angles around inflection points and singular points, several middle layers exhibit a sharp increase in electric field intensity.

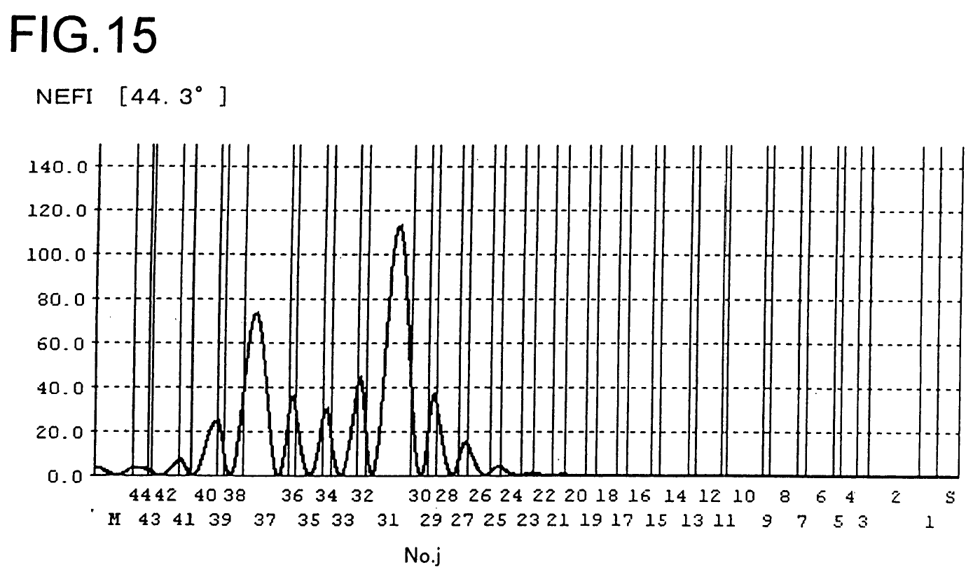

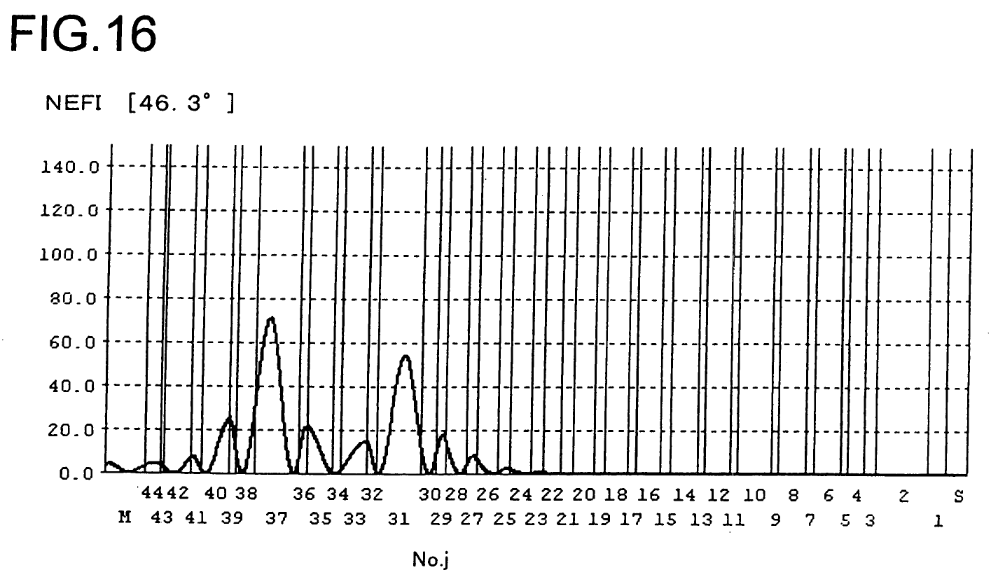

FIGS. 15 and 16 show the electric field intensity distribution of s-polarized light (with a wavelength λ of 405 nm) as observed at incidence angles θ of 44.3° and 46.3°, where inflection and singular points are observed, with the scale of the vertical axis magnified by a factor of 10. As will be understood from the electric field intensity distribution shown in FIGS. 15 and 16, the eighth layer (i=8, j=37) and the fourteenth layer (i=14, j=31) exhibit a sharp increase in electric field intensity. Now, with respect to the electric field intensity distribution at incidence angles where inflection or singular points are observed, how the phase shift changes as the film thicknesses of several middle layers (hereinafter referred to as the “key layers”) that exhibit a sharp increase in electric field intensity are varied from the design values thereof will be studied.

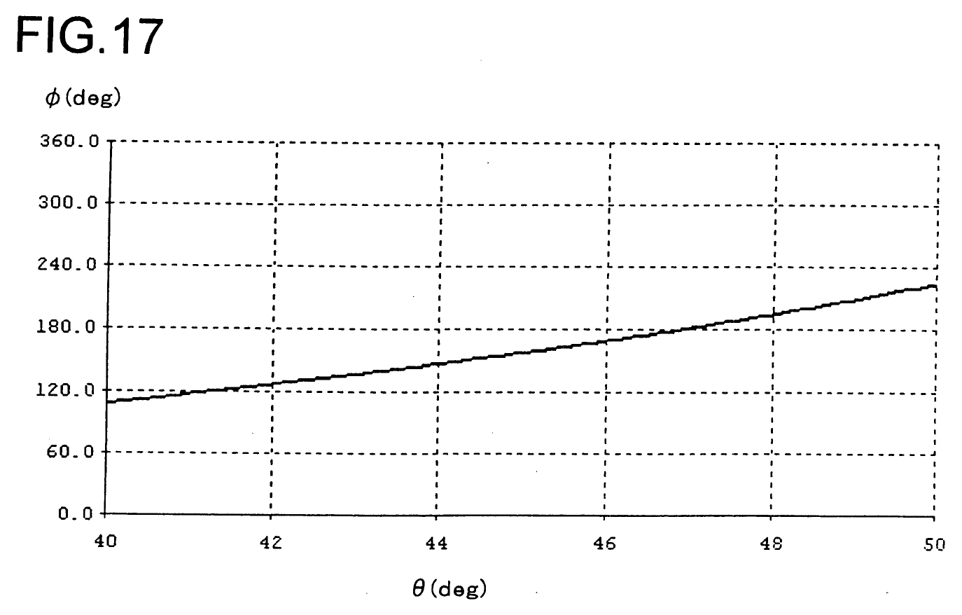

In the first PBS, the value of QWOT of the eighth layer (i=8, j=37) is varied from 3 to 1.703, and the value of QWOT of the fourteenth layer (i=14, j=31) is varied from 3 to 2. Using the resulting polarization beam splitter film, a second PBS is built. FIG. 17 shows the reflection-induced phase shift φ(°) of s-polarized light (with a wavelength λ of 405 nm) as observed in the range of incidence angles θ from 40° to 50° in the second PBS. As will be understood from FIG. 17, cleared of inflection and singular points, the reflection-induced phase shift φ of s-polarized light varies linearly with respect to the variation of the incidence angle θ.

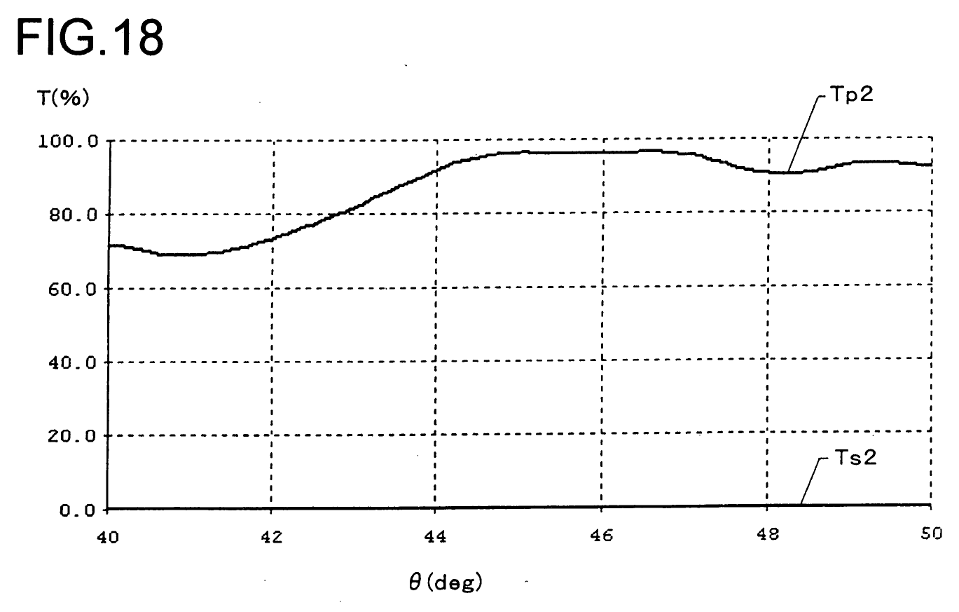

FIG. 18 shows the polarization separation characteristics of the second PBS in terms of transmissivity T(%). FIG. 18 shows the transmissivity Tp2 of p-polarized light and the transmissivity Ts2 of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 18, the adjustment of the film thicknesses of the key layers helps remove inflection and singular points from the desired range of incidence angles (FIG. 17), but this is achieved at the sacrifice of the polarization separation characteristics (i.e., resulting in a lowering of the transmissivity Tp2 of p-polarized light at incidence angles from 40° to 43°).

To overcome this, while the film thicknesses of and around the key layers are kept constant, the film thicknesses of layers other than the key layers are adjusted to improve the polarization separation characteristics. As an example of the result of this process, Tables 3 and 4 show the multiple-layer construction of a third PBS (QWOT=4·n·d/λ0, where d represents the physical film thickness; n represents the refractive index; and λ0 represents the design wavelength). In the polarization beam splitter film of the third PBS, on a glass substrate M (with a refractive index of 1.64) disposed on the light-entrance side, there are laid a total of 41 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between.

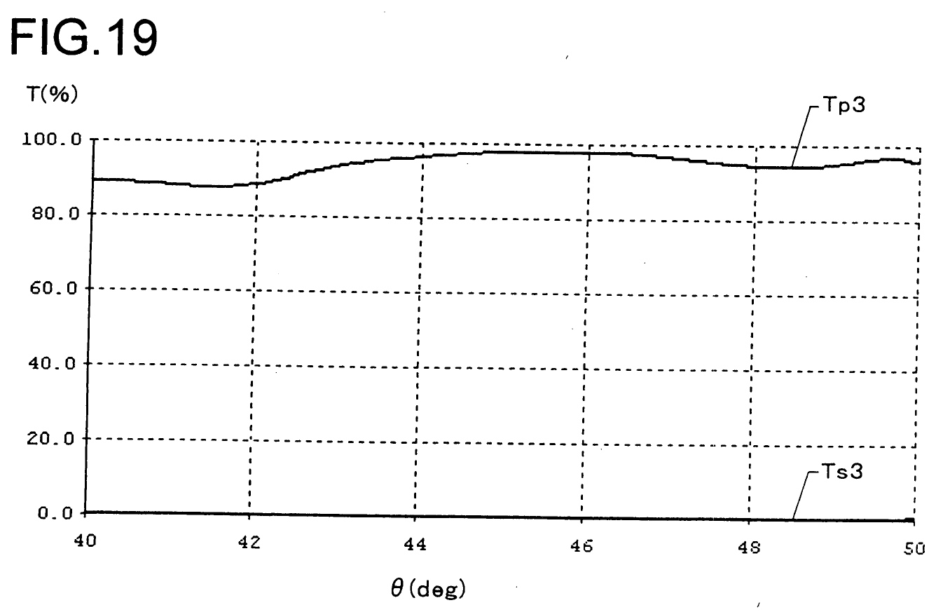

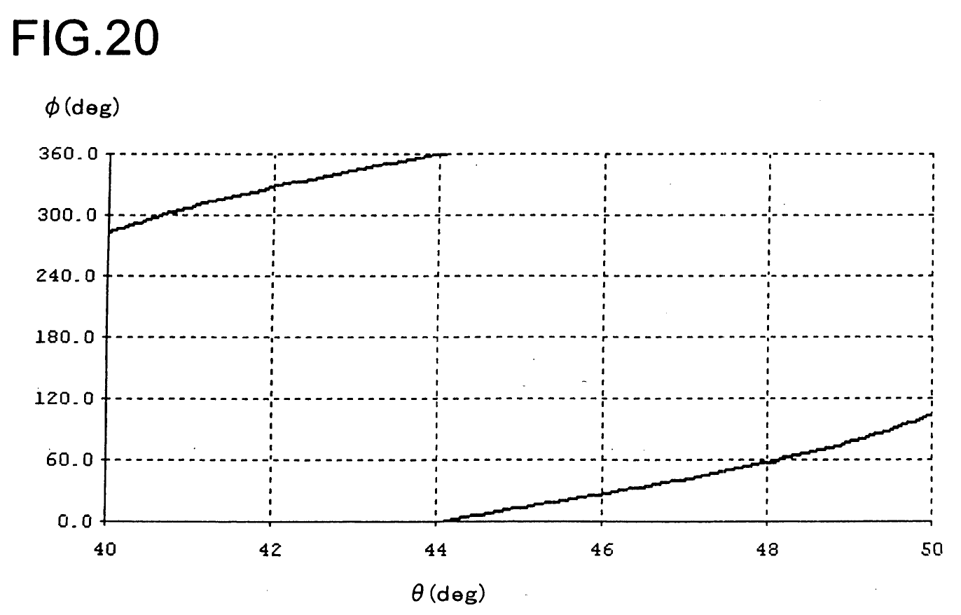

FIG. 19 shows the polarization separation characteristics of the third PBS in terms of transmissivity T(%). FIG. 19 shows the transmissivity Tp3 of p-polarized light and the transmissivity Ts3 of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). FIG. 20 shows the reflection-induced phase shift φ(°) of s-polarized light (with a wavelength λ of 405 mn) as observed in the range of incidence angles θ from 40° to 50° in the third PBS. As will be understood from FIG. 20, cleared of singular points, the reflection-induced phase shift φ of s-polarized light varies linearly with respect to the variation of the incidence angle.

By adjusting film thicknesses with attention focused on the key layers as described above, it is possible to make the phase shift linear. Even if this deforms the polarization separation characteristics, by adjusting the film thicknesses of layer other than the key layers, it is possible to improve the polarization separation characteristics. These processes, however, produce the following problems.

A first problem is a slight overall degradation of the polarization separation characteristics. For the purpose of making the phase shift linear, film thicknesses need to be adjusted at the cost of slightly degrading the polarization separation characteristics. This degradation may matter in a case where stringent polarization separation characteristics are required. By contrast, attempting to maintain satisfactory polarization separation characteristics makes it impossible to remove inflection and singular points on the phase shift curve from the desired ranges of incidence angles and of wavelengths. The resulting irregular variations of the phase shift lower the wavefront accuracy of s-polarized light.

A second problem is the considerably long time required for film thickness adjustment. This process involves manual operations whereby first the film thicknesses of the key layers are adjusted and then the film thicknesses of other layers are adjusted so as to improve the polarization separation characteristics. This takes time. To enhance the polarization separation characteristics and simultaneously make the phase shift linear, it is necessary to pay attention to both the polarization separation characteristics and the phase shift all the time. This is troublesome.

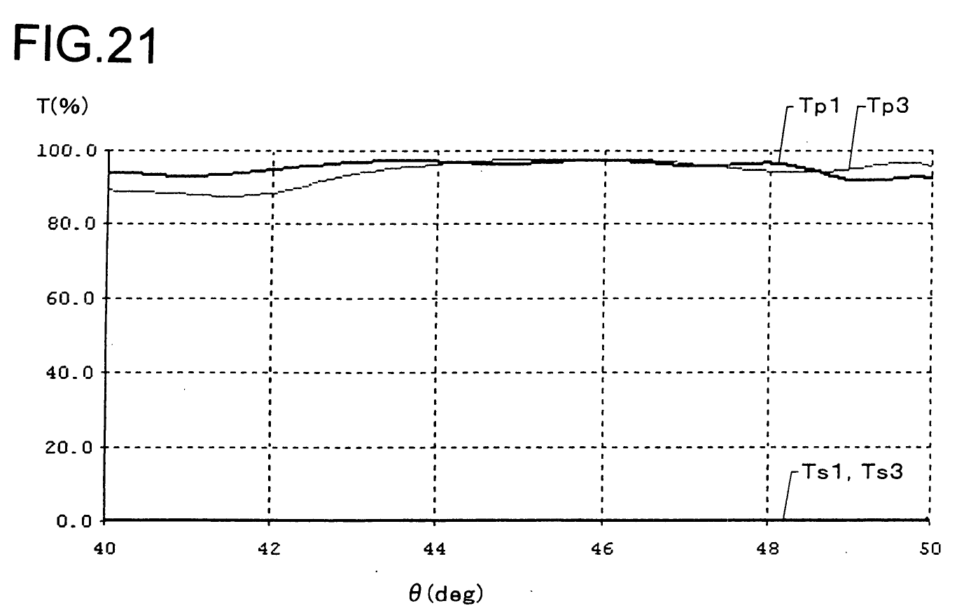

To make the above-mentioned degradation of the polarization separation characteristics clear, FIG. 21 shows, together, the polarization separation characteristics of both the first and third PBSs (shown respectively in FIGS. 2 and 19) in terms of transmissivity T(%). FIG. 21 shows the transmissivity Tp1 (thick line) and Tp3 (thin line) of p-polarized light and the transmissivity Ts1 and Ts3 of s-polarized light as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 21, film thickness adjustment results in higher p-polarized light transmissivity around incidence angles θ from 49° to 50° and generally lower p-polarized light transmissivity around incidence angles from 40° to 44°.

Considering the performance of currently available blue lasers, of which the oscillation wavelengths vary slightly from one another, a certain degree of p-/s-polarization separation performance is required also at wavelengths slightly higher and lower than 405 nm. Accordingly, as well as variation in incidence angle, variation in wavelength needs to be taken into consideration in the stages of designing and film formation.

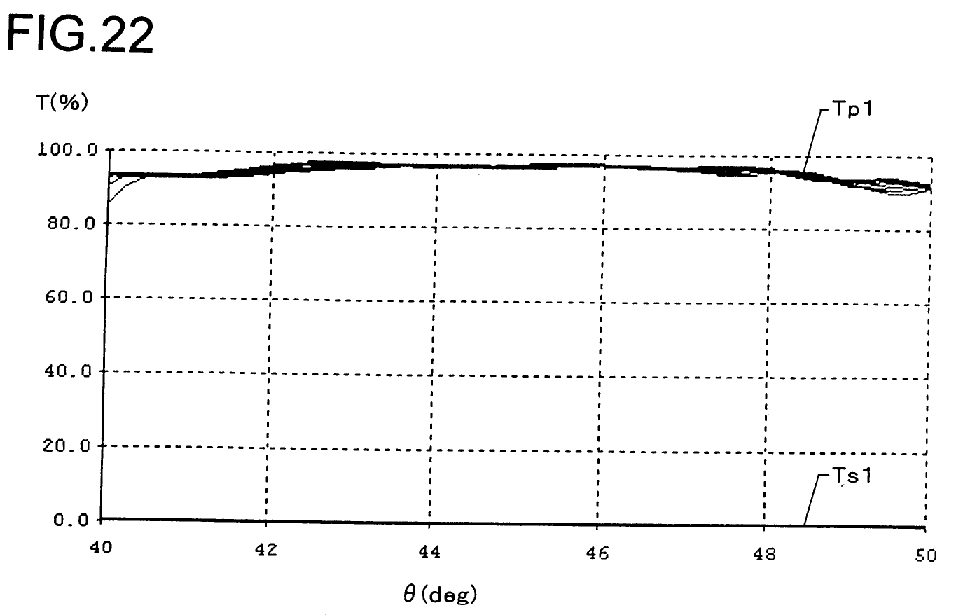

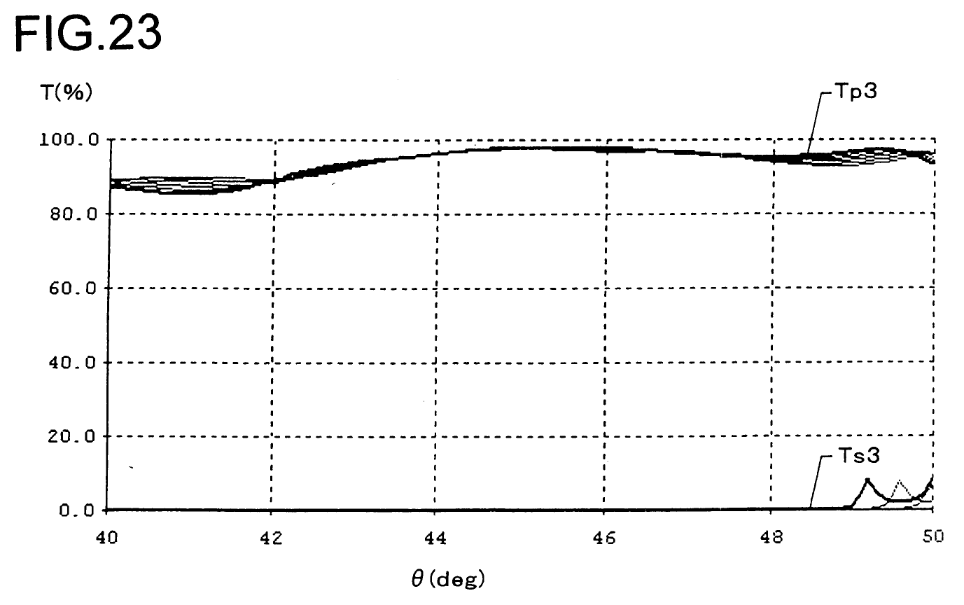

To make clear the deterioration of the polarization separation characteristics ascribable to variation in wavelength, FIG. 22 shows, in terms of transmissivity T(%), the polarization separation characteristics plotted at 2 nm increments as observed in the range of wavelengths of 405±5 nm in the first PBS, and FIG. 23 shows, in terms of transmissivity T(%), the polarization separation characteristics plotted at 2 nm increments as observed in the range of wavelengths of 405±5 nm in the third PBS. FIGS. 22 and 23 show the transmissivity Tp1 and Tp3 of p-polarized light and the transmissivity Ts1 and Ts3 of s-polarized light as observed in the range of wavelengths λ from 400 nm to 410 nm, in the range of incidence angles θ from 40° to 50° with respect to the film surface (i.e., in the ±5° range of incidence angles with respect to the reference incidence angle θ0 of 45°). As will be clear from FIGS. 22 and 23, adjusting film thicknesses with a view to making the phase shift linear results in not only lower p-polarized light transmissivity, but also somewhat deformed s-polarized light transmissivity around a incidence angle θ of 50°.

To overcome this problem, it is necessary to devise a process whereby inflection points and the like on a distorted phase shift curve are removed from the desired range of incidence angles and the like with a minimum degradation of the polarization separation characteristics. As one such process, reversing of the film construction will be described below. In a common multiple-layer construction, even when the order in which the layers thereof are arranged is reversed (i.e., even when the layers arranged in a given order from the light-entrance side to the light-exit side is converted so as to be arranged in the same order from the light-exit side to the light-entrance side), so long as the construction otherwise remains the same (for example, with the light-entrance side medium, i.e., the substrate M, and the light-exit-side medium, i.e., the substrate E, remaining the same), the obtained polarization separation characteristics remain the same. However, the electric field intensity distribution does change, resulting in a completely changed pattern of the phase shift. This change can be accompanied by removal of inflection and singular points on the phase shift curve from the desired ranges of incidence angles and of wavelengths. That is, simply by reversing the order of layer arrangement of the polarization beam splitter film alone, it is possible to improve the phase shift while maintaining satisfactory polarization separation characteristics. Now, how the phase shift is improved by reversing the order of layer arrangement of the first PBS (i.e., by reversing the film construction) will be studied.

The order of layer arrangement in the first PBS is reversed to obtain a fourth PBS. Tables 5 and 6 show the multiple-layer construction of the fourth PBS (QWOT=4·n·d/λ0, where d represents the physical film thickness; n represents the refractive index; and λ0 represents the design wavelength). In the polarization beam splitter film of the fourth PBS, on a glass substrate M (with a refractive index of 1.64) disposed on the light-entrance side, there are laid a total of 44 layers (the total number of layers is represented by N) that are given successive numbers (the number of a given layer is represented by i) in the order in which they are laid. These layers consist of films of a high-refractive-index material, namely a mixture TX containing TiO₂ (titanium oxide), and films of a low-refractive-index material, namely MgF₂ (magnesium fluoride) or SiO₂ (silicon oxide). The last layer, i.e., the one farthest from the light-entrance-side glass substrate M, is bonded to a glass substrate E (with a refractive index of 1.64) disposed on the light-exit side, with an adhesive layer S (with a refractive index of 1.52) interposed in between. That is, as will be clear from comparison with the multiple-layer construction of the first PBS (Tables 1 and 2), the order in which the layers are arranged from the light-entrance-side to the light-exit side in the fourth PBS is the same as the order in which the layers are arranged from the light-exit-side to the light-entrance side in the first PBS.

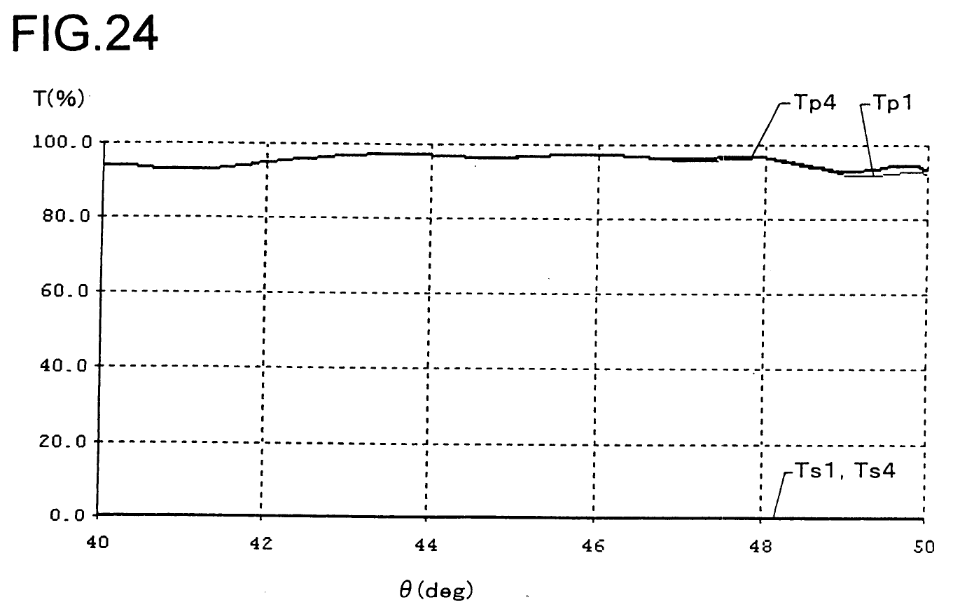

FIG. 24 shows, together, the polarization separation characteristics of both the first and fourth PBSs in terms of transmissivity T(%). FIG. 24 shows the transmissivity Tp1 (thin line) of p-polarized light in the first PBS, the transmissivity Tp4 (thick line) of p-polarized light in the fourth PBS, and the transmissivity Ts1 and Ts4 of s-polarized light in the first and fourth PBSs, all as observed at a wavelength λ of 405 nm, in the range of incidence angles θ from 40° to 50° with respect to the film surface (i.e., in the ±5° range of incidence angles with respect to the reference incidence angle θ0 of 45°). As will be understood from FIG. 24, the polarization separation characteristics of the first and fourth PBSs largely overlap, indicating no degradation of the polarization separation characteristics resulting from the reversing of the film construction. Accordingly, the fourth PBS has satisfactory polarization separation characteristics exhibiting low incidence-angle dependence, and is thus suitable as a polarization beam splitter for a blue laser.

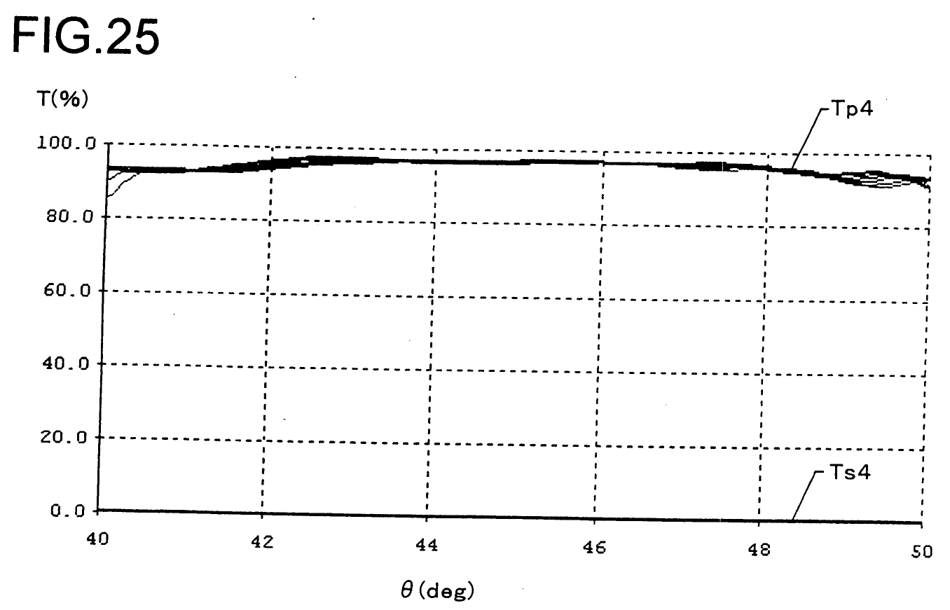

FIG. 25 shows, in terms of transmissivity T(%), the polarization separation characteristics plotted at 2 nm increments as observed in the range of wavelengths of 405±5 nm in the fourth PBS. FIGS. 25 show the transmissivity Tp4 of p-polarized light and the transmissivity Ts4 of s-polarized light as observed in the range of wavelengths λ from 400 nm to 410 nm, in the range of incidence angles θ from 40° to 50° with respect to the film surface (i.e., in the ±5° range of incidence angles with respect to the reference incidence angle θ0 of 45°). As will be clear from FIG. 25, varying the wavelength in the range of 405±5 nm hardly affects the polarization separation characteristics.

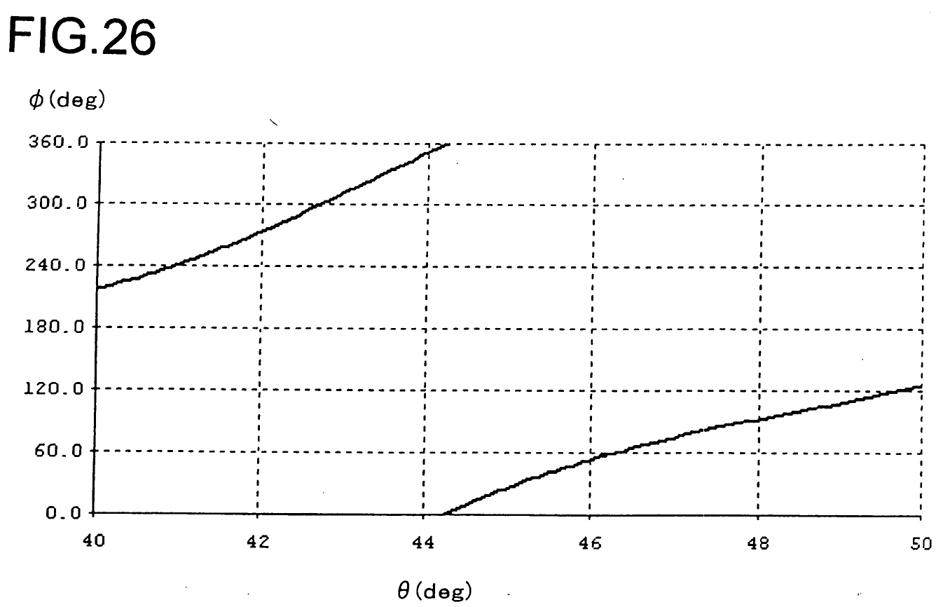

FIG. 26 shows the reflection-induced phase shift φ(°) of s-polarized light (with a wavelength λ of 405 nm) as observed in the range of incidence angles θ from 40° to 50° in the fourth PBS. As will be understood from FIG. 26, cleared of inflection and singular points, the reflection-induced phase shift φ of s-polarized light varies linearly with respect to the variation of the incidence angle.

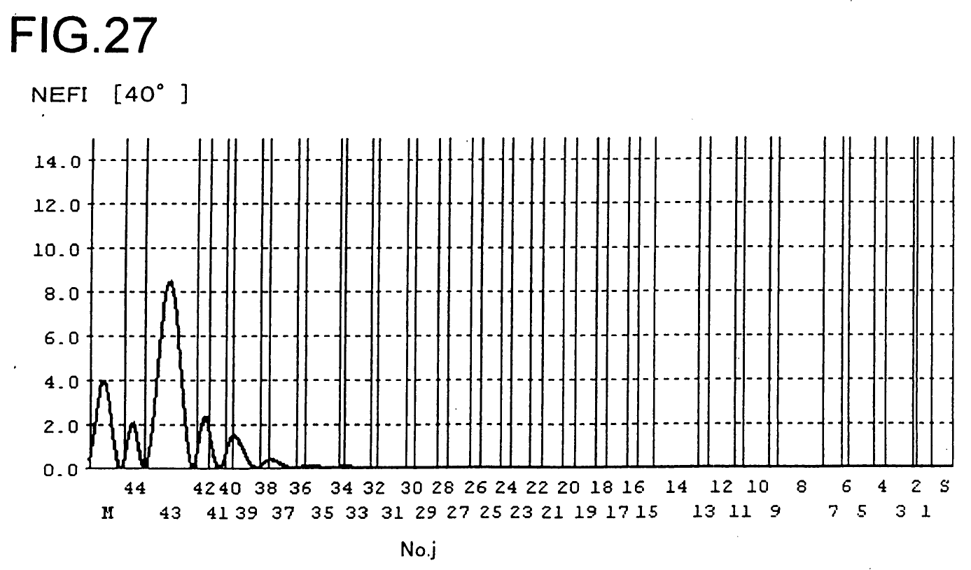

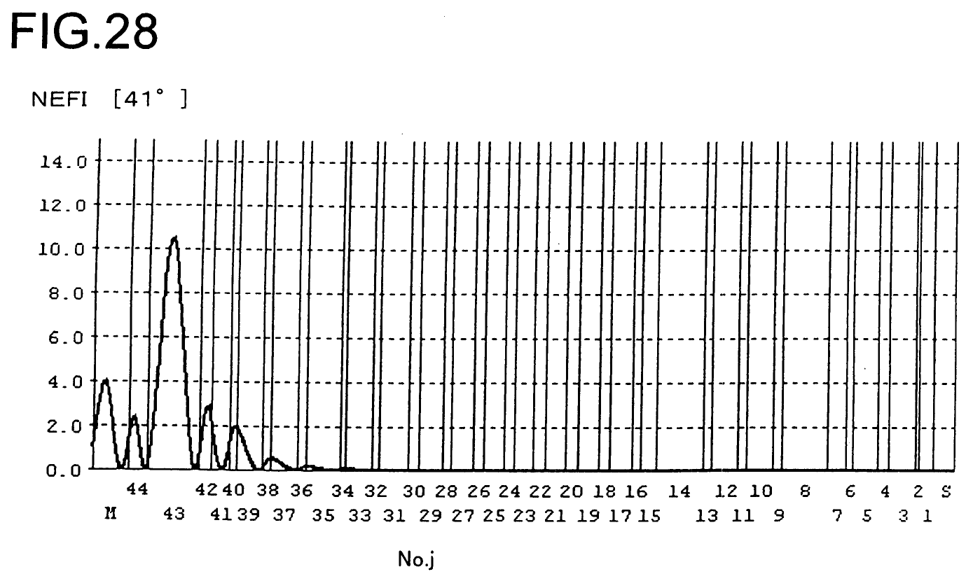

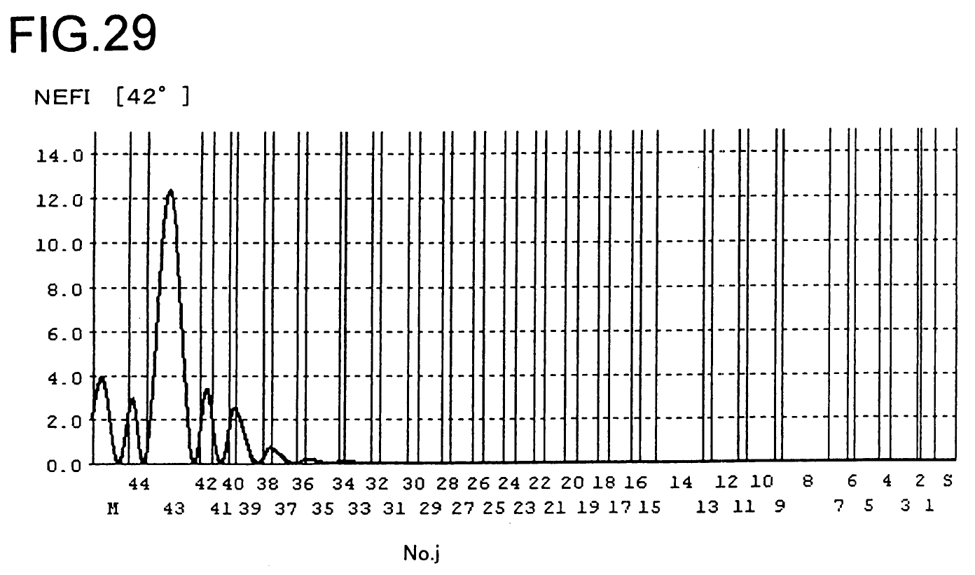

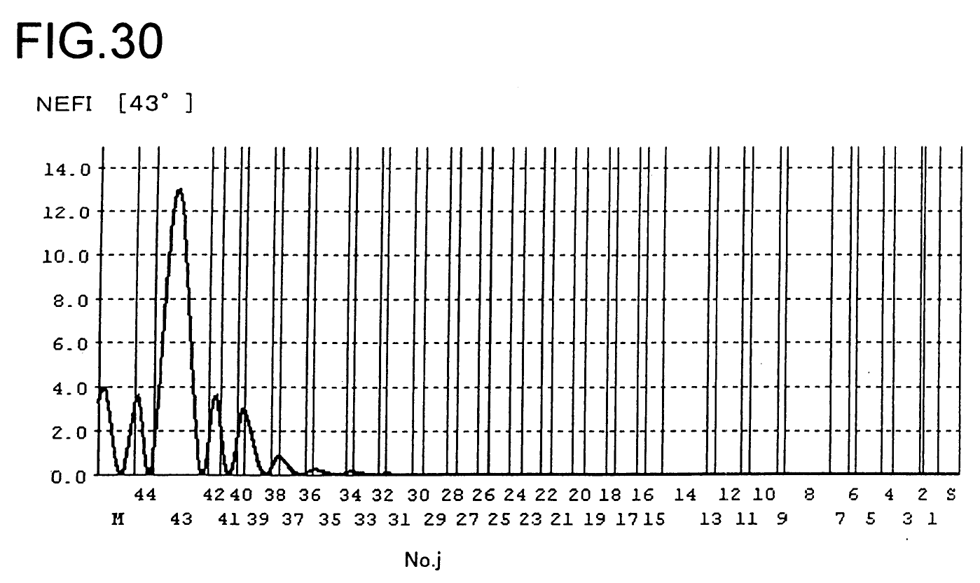

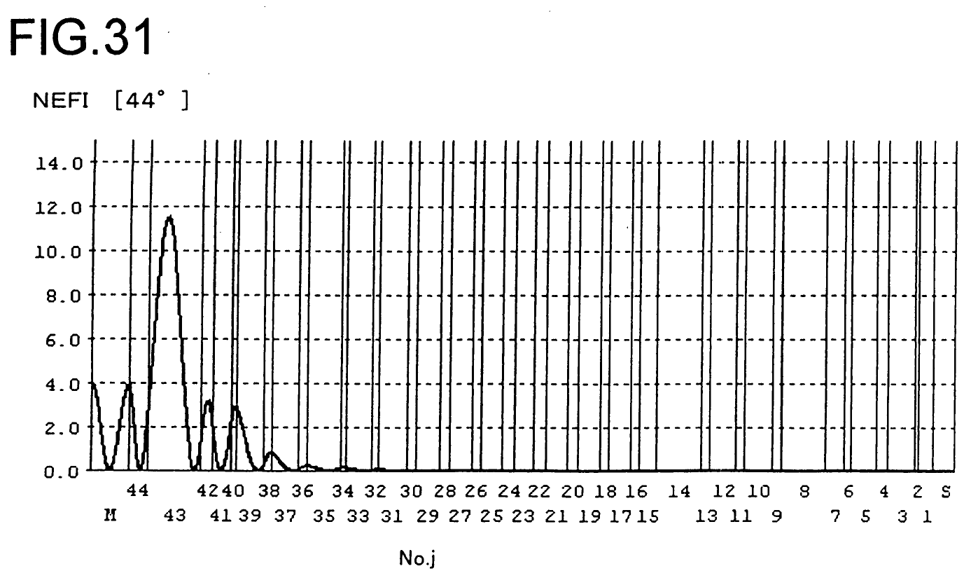

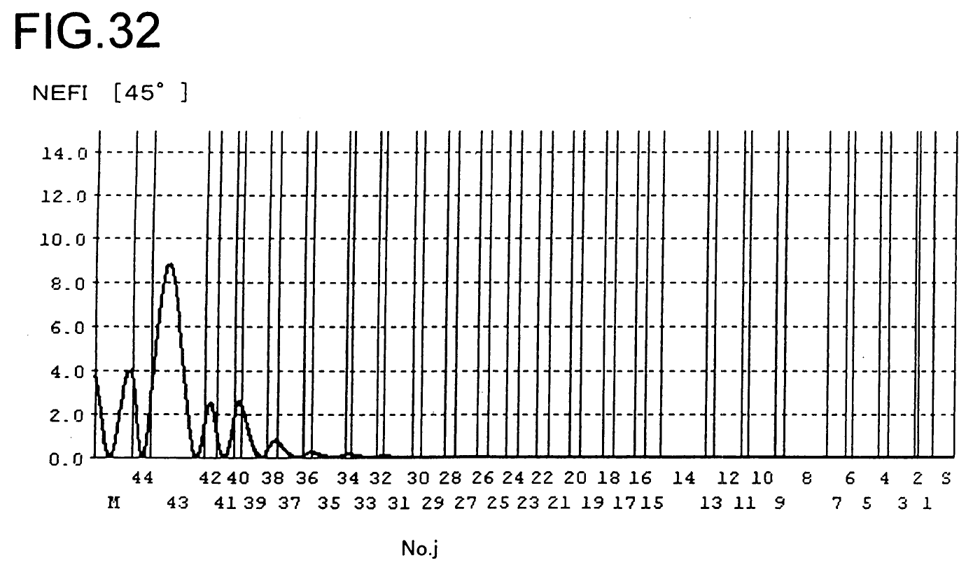

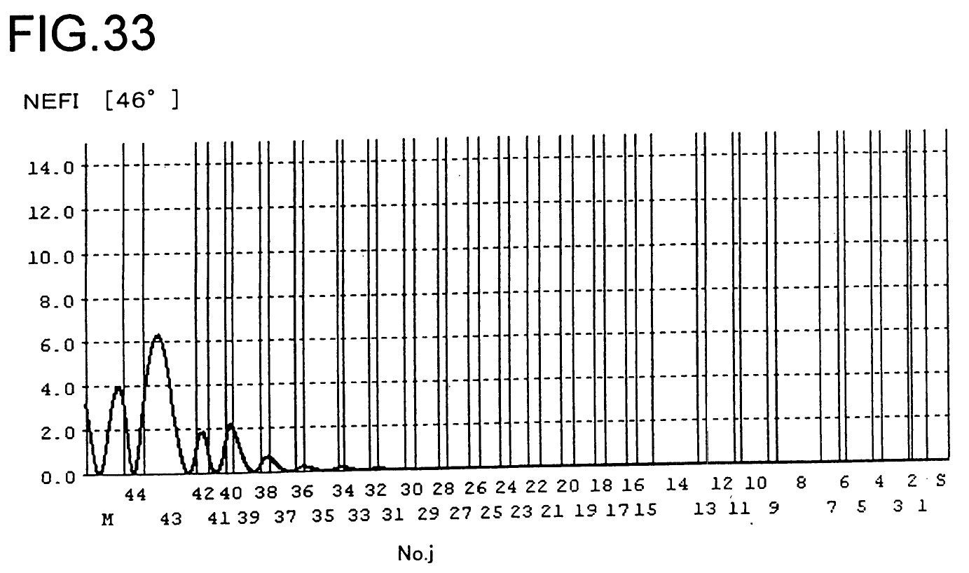

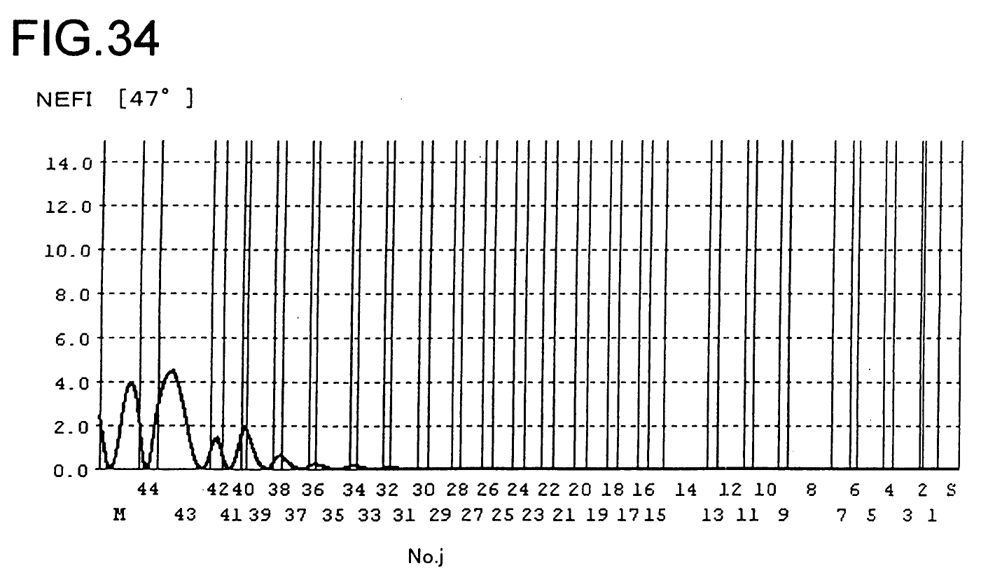

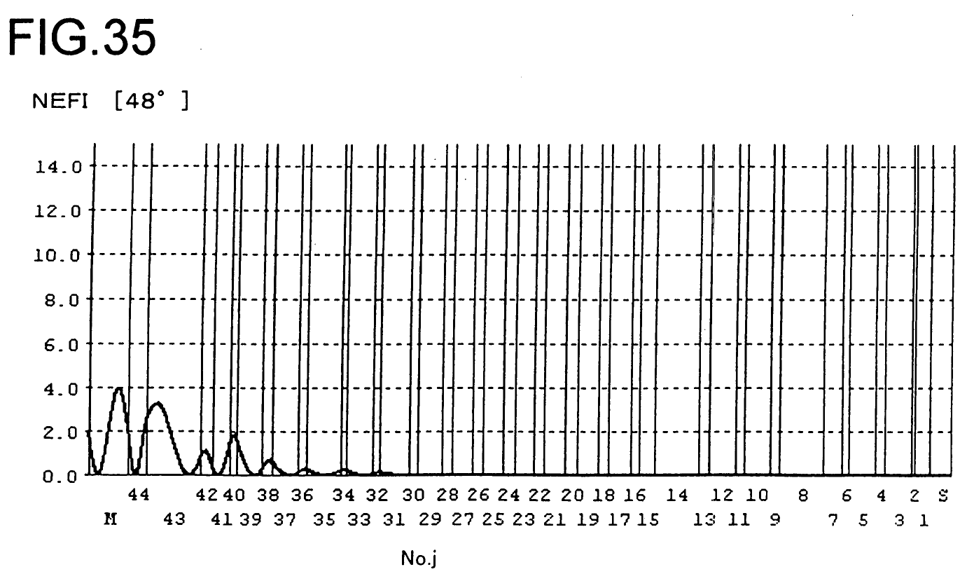

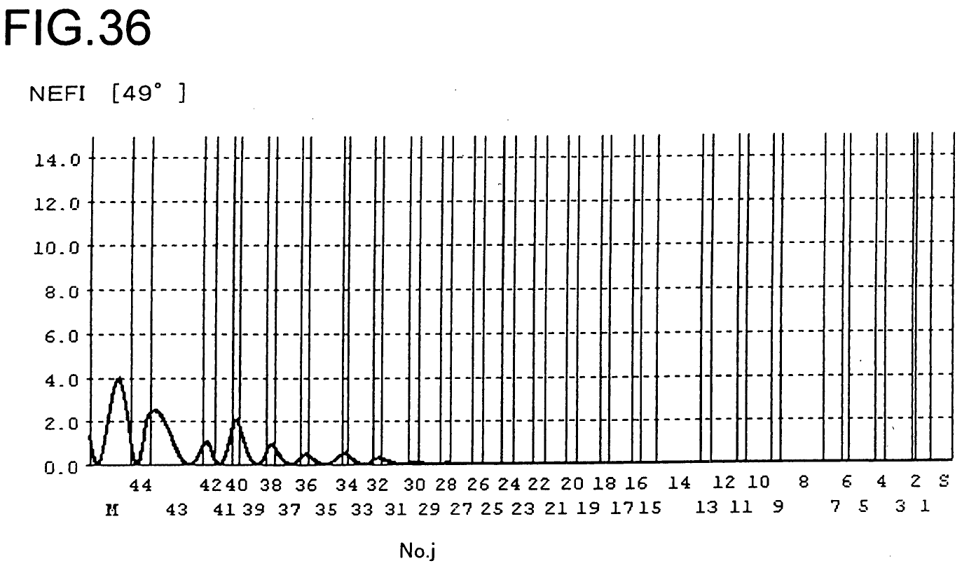

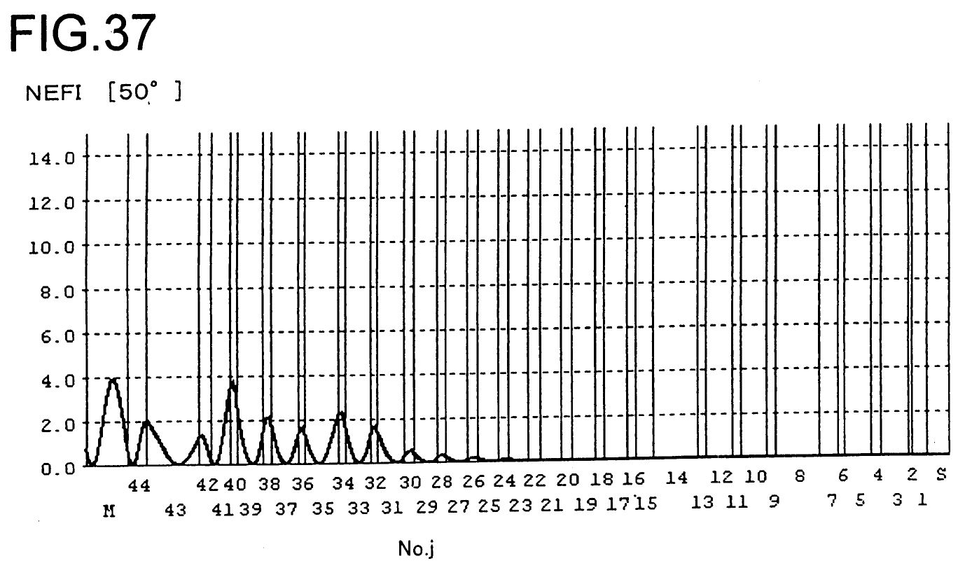

FIGS. 27 to 37 show the electric field intensity distribution of s-polarized light (with a wavelength λ of 405 nm) as observed at each integer angle in the range of incidence angles θ from 40° to 50° in the fourth PBS. In the graphs of FIGS. 27 to 37, the horizontal axis represents the multiple-layer construction from the glass substrate M (on the light-entrance side) to the adhesive layer S; the intervals between vertical lines correspond to the ranges of physical thicknesses d of the individual layers. It should be noted that, here, the number given to each layer is a reversed number j, which with respect to the layer number i fulfils the relationship expressed by the formula j=(N+1)−i (where N represents the total number of layers). In the graphs of FIGS. 27 to 37, the vertical axis represents the normalized electric field intensity (NEFI) of the layers. As will be understood from FIGS. 27 to 37, in the range of incidence angles θ from 40° to 50°, no sharp increase in electric field intensity is observed.

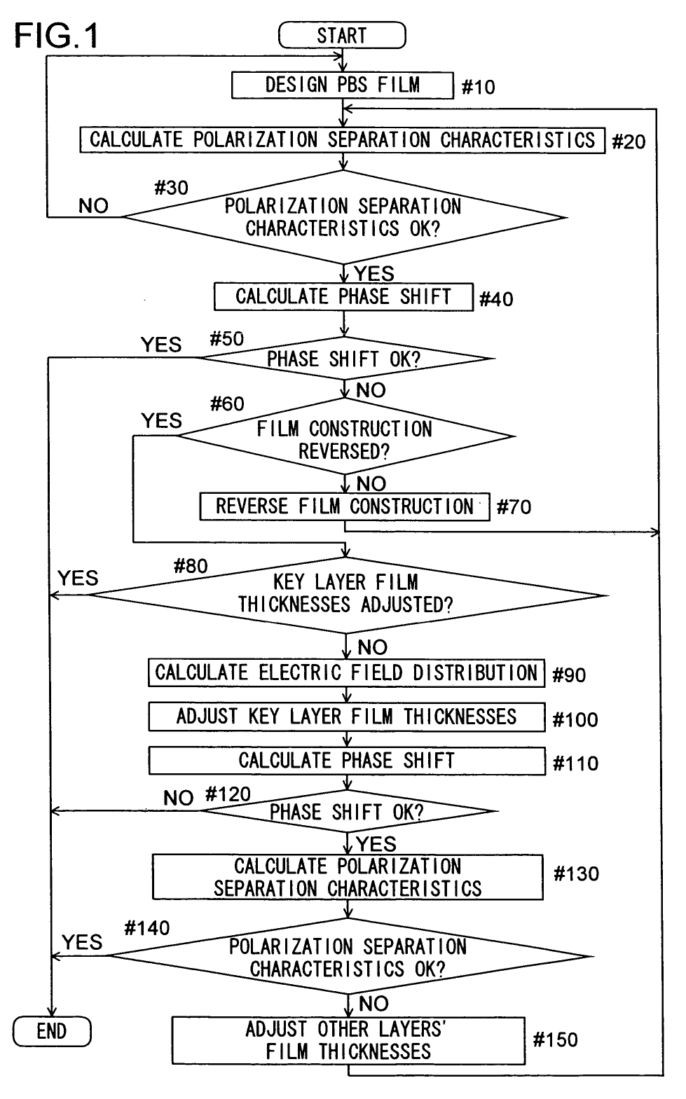

By using the processes of designing the first to fourth PBSs described above, it is possible, while maintaining satisfactory polarization separation characteristics exhibiting low incidence-angle dependence, to easily make the phase shift of the s-polarized light reflected from the polarization beam splitter film linear so that s-polarized light is reflected with high wavefront accuracy. Now, an example of a method of adjusting the phase shift which exploits the processes of designing the first to fourth PBSs will be described with reference to the flow chart of FIG. 1 and other figures.

First, a polarization beam splitter film (PBS film) is designed (step #10). Then, its polarization separation characteristics are calculated (#20), and whether or not they are satisfactory and exhibit low incidence-angle dependence is checked (#30). If the obtained polarization separation characteristics are not as desired, the flow returns to step #10. If, for example as in the first PBS (FIG. 2), satisfactory polarization separation characteristics are obtained for divergent light incident in a range of incidence angles as wide as ±5° or more, then the reflection-induced phase shift of s-polarized light as observed in the desired range of incidence angles and in the desired range of wavelengths (in the case of the first PBS, FIG. 3) is calculated (#40). Then, whether or not the reflection-induced phase shift of s-polarized light varies linearly with respect to the variation of the incidence angle is checked (#50).

When satisfactory linearity is achieved, for example, if the range of incidence angles is ±5° of a predetermined value (in the first to fourth PBSs, 45°) and if the deviation of the phase shift from the linear function determined by the phase shifts at the minimum and maximum incidence angles is within ±50° over the entire range of incidence angles, the flow is ended. If, in the desired range of incidence angles and in the desired range of wavelengths, the reflection-induced phase shift of s-polarized light is not linear with respect to the incidence angle, i.e., if the phase shift curves have inflection points and the like, the process for enhancing the wavelength accuracy of s-polarized light is started. Specifically, first, whether or not the film construction has already been reversed is checked (#60). If the film construction has already been reversed, then whether or not the film thicknesses of the key layers have already been adjusted is checked (#80); if not, the film construction is reversed (#70).

In step #70, the order in which the layers of the polarization beam splitter film are arranged is reversed. That is, the multiple-layer construction having the layers thereof arranged in the order expressed with their layer numbers as i=1, 2, 3, . . . , N−2, N−1, and N, is converted into one having the layer thereof arranged in the order expressed with their layer numbers as i=N, N−1, N−2, . . . , 2, 3, and 1. Thus, as a result of the reversing, the layer number i of each layer is superseded by the layer number j, which with respect to the layer number i fulfils the relationship expressed by the formula j=(N+1)−i, the layer i now called the layer j. If the reversing of the film construction has been successful in removing inflection points and singular points from the desired range of incidence angles, then, as in the fourth PBS (FIG. 26), the reflection-induced phase shift of s-polarized light now varies linearly with respect to the variation of the incidence angle. This makes it possible to reflect s-polarized light with high wavelength accuracy.

After the reversing of the film construction (#70), the flow returns to step #20 to make calculations, judgments, and the like relating to the polarization separation characteristics and the phase shift anew (#20 to #50). If, for example as in the fourth PBS (FIG. 26), the reflection-induced phase shift of s-polarized light varies linearly with respect to the variation of the incidence angle, the phase shift is found to have been improved, and thus the flow is ended. If the phase shift is found not to have been improved, whether or not the film thicknesses of the key layers have already been adjusted is checked (#80). If the film thicknesses of the key layers have already been adjusted, the flow is ended; if not, the electric field intensity distribution (in the case of the first PBS, FIGS. 4 to 14) is calculated (#90), and the film thicknesses of the key layers are adjusted (#100) so that inflection points and singular points are removed from the desired range of incidence angles.

Then, the reflection-induced phase shift of s-polarized light in the desired range of incidence angles and in the desired range of wavelengths is calculated (#110), and whether or not the reflection-induced phase shift of s-polarized light varies linearly with respect to the variation of the incidence angle is checked (#120). If the desired linearity is not achieved, the flow is ended. If the desired linearly is achieved, to check whether or not, as a result of the film thickness adjustment of the key layers (#110), the polarization separation characteristics have been deformed, the polarization separation characteristics are calculated (#130) and evaluated (#140). If the desired polarization separation characteristics are achieved, the flow is ended; if not, the film thicknesses of other layers are adjusted (#150), and then the flow returns to step #20. It should be noted that adjusting the film thicknesses of layers other than the key layers does not cause singular points and the like to move.

By reversing the film construction (#70) as described above, it is possible to move inflection points, singular points, and the like without almost no degradation of the polarization separation characteristics. The reversing of the film construction, however, may introduce extra inflection and singular points. To avoid this, as shown in the flow chart (FIG. 1), it is preferable first to choose whichever is more likely to achieve linearity, performing it before or after the reversing, and thereafter to gradually make fine adjustments (#90 to #150). This makes it possible to achieve linearity considerably efficiently.

In the second to fourth PBSs described above, at a wavelength λ of 405 nm and in the range of incidence angles θ from 40° to 50°, the reflection-induced phase shift of s-polarized light varies linearly with respect to the variation of the incidence angle. When the variation of the phase shift exhibits regularity in this way, it is possible, on the basis of the relationship between the incidence angle θ and the phase shift φ, to easily predict and adjust the phase shift. Accordingly, as in the second to fourth PBSs, in the desired range of incidence angles and in the desired range of wavelengths, by controlling the reflection-induced phase shift of s-polarized light linearly with respect to the incidence angle, it is possible to reflect s-polarized light with high wavelength accuracy while maintaining polarization separation characteristics exhibiting low incidence-angle dependence. Thus, in the desired range of incidence angles and in the desired range of wavelengths, by using a polarization beam splitter film in which the reflection-induced phase shift of s-polarized light varies linearly with respect to the variation of the incidence angle, or a transparent optical component provided therewith, in an optical system that receives incident light having a large divergence angle but that nevertheless requires satisfactory p-/s-polarization separation characteristics (for example, the optical system of an optical pickup using a blue laser), it is possible to dramatically enhance the wavefront accuracy of the light reflected from the polarization beam splitter film, and thereby to obtain excellent optical performance and other benefits.

At incidence angles at which the phase shift varies irregularly, i.e., at incidence angles at which inflection points appear in the phase shift, part of the layers, specifically, the key layers, exhibit a sharp increase in electric field intensity. Accordingly, in the desired range of incidence angles and in the desired range of wavelengths, to control the reflection-induced phase shift of s-polarized light linearly with respect to the incidence angle as in the second to fourth PBSs, it is preferable, in the desired range of incidence angles and in the desired range of wavelengths, that the electric field intensity of s-polarized light as observed from the light-entrance side, where the substrate is located, to the light-exit side be controlled to be less than or equal to four times, preferably less than or equal to three times, and more preferably less than or equal to, the electric field intensity as observed in the substrate, and that the peaks of the electric field intensity distribution be controlled to decrease largely monotonically.

In the desired range of incidence angles and in the desired range of wavelengths, if the electric field intensity distribution of s-polarized light as observed from the light-entrance side, where the substrate is located, to the light-exit side exhibits an increase exceeding a predetermined value (for example, four times the electric field intensity as observed in the substrate), it is preferable that, as in the second PBS, the film thicknesses of the layers in which the electric field intensity distribution of s-polarized light exhibits the increase be so adjusted that the electric field intensity is reduced down to or below a predetermined value (for example, less than or equal to four times, preferably less than or equal to three times, and more preferably less than or equal to, the electric field intensity as observed in the substrates). By adjusting the film thicknesses of the key layers, which exhibit a sharp increase in electric field intensity, it is possible to make the phase shift linear, and thereby to give regularity to the variation of the phase shift.

Moreover, it is preferable that the range of incidence angles be ±5° of a predetermined value (in the first to fourth PBSs, 45°), and that the deviation of the phase shift from the linear function determined by the phase shifts observed at the minimum and maximum incidence angles be ±50° or less over the entire range of incidence angles. It is more preferable that the deviation of the phase shift be ±20° or less, and, further preferably, ±10° or less. Moreover, it is preferable that the phase shift vary smoothly with respect to the incidence angle. As in the second to fourth PBSs, by limiting the range of incidence angles to ±5° of a predetermined value, and in addition limiting the deviation of the phase shift from the linear function determined by the phase shifts observed at the minimum and maximum incidence angles to ±50° (preferably, ±20°, and, more preferably, ±10°) or less over the entire range of incidence angles, it is possible to achieve enhanced wavelength accuracy as is more suitable for the optical system of an optical pickup using a blue laser.

TABLE 1
First PBS (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | MgF₂ | 73.10 | 1.000 |
| 2 | TX | 19.09 | 0.400 |
| 3 | MgF₂ | 123.55 | 1.690 |
| 4 | TX | 52.50 | 1.100 |
| 5 | SiO₂ | 124.27 | 1.800 |
| 6 | TX | 31.50 | 0.660 |
| 7 | MgF₂ | 87.73 | 1.200 |
| 8 | SiO₂ | 207.11 | 3.000 |
| 9 | TX | 38.19 | 0.800 |
| 10 | MgF₂ | 122.08 | 1.670 |
| 11 | TX | 38.66 | 0.810 |
| 12 | MgF₂ | 119.89 | 1.640 |
| 13 | TX | 42.96 | 0.900 |
| 14 | SiO₂ | 207.11 | 3.000 |
| 15 | MgF₂ | 73.10 | 1.000 |
| 16 | TX | 43.44 | 0.910 |
| 17 | SiO₂ | 98.72 | 1.430 |
| 18 | TX | 45.34 | 0.950 |
| 19 | MgF₂ | 98.69 | 1.350 |
| 20 | TX | 52.50 | 1.100 |
| 21 | MgF₂ | 95.04 | 1.300 |
| 22 | TX | 53.46 | 1.120 |
| 23 | SiO₂ | 86.30 | 1.250 |
| 24 | TX | 53.46 | 1.120 |
| 25 | MgF₂ | 93.57 | 1.280 |

TABLE 2
First PBS (λ0 = 405 nm)

| | | Physical Film | |
|---|---|---|---|
| | | Thickness | QWOT |
| Layer No. i | Material | d (nm) | (4 · n · d/λ0) |
| 26 | TX | 46.59 | 0.976 |
| 27 | MgF₂ | 100.88 | 1.380 |
| 28 | TX | 44.72 | 0.937 |
| 29 | SiO₂ | 109.77 | 1.590 |
| 30 | TX | 44.20 | 0.926 |
| 31 | MgF₂ | 130.49 | 1.785 |
| 32 | TX | 33.89 | 0.710 |
| 33 | MgF₂ | 119.16 | 1.630 |
| 34 | TX | 25.54 | 0.535 |
| 35 | SiO₂ | 158.79 | 2.300 |
| 36 | TX | 37.42 | 0.784 |
| 37 | MgF₂ | 122.82 | 1.680 |
| 38 | TX | 40.57 | 0.850 |
| 39 | MgF₂ | 125.01 | 1.710 |
| 40 | TX | 30.55 | 0.640 |
| 41 | SiO₂ | 81.46 | 1.180 |
| 42 | TX | 55.37 | 1.160 |
| 43 | MgF₂ | 248.56 | 3.400 |
| 44 | TX | 88.30 | 1.850 |

Adhesive Layer S (Refractive Index: 1.52)
Glass Substrate E (Refractive Index: 1.64)

TABLE 3
Third PBS (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | MgF₂ | 147.75 | 2.021 |
| 2 | SiO₂ | 212.86 | 3.083 |
| 3 | TX | 31.50 | 0.660 |
| 4 | MgF₂ | 87.73 | 1.200 |
| 5 | SiO₂ | 117.57 | 1.703 |
| 6 | TX | 38.19 | 0.800 |
| 7 | MgF₂ | 122.08 | 1.670 |
| 8 | TX | 38.66 | 0.810 |
| 9 | MgF₂ | 119.89 | 1.640 |
| 10 | TX | 42.96 | 0.900 |
| 11 | SiO₂ | 138.07 | 2.000 |
| 12 | MgF₂ | 73.10 | 1.000 |
| 13 | TX | 43.44 | 0.910 |
| 14 | SiO₂ | 98.72 | 1.430 |
| 15 | TX | 45.34 | 0.950 |
| 16 | MgF₂ | 98.69 | 1.350 |
| 17 | TX | 33.39 | 0.700 |
| 18 | MgF₂ | 99.48 | 1.361 |
| 19 | TX | 52.23 | 1.094 |
| 20 | SiO₂ | 107.23 | 1.553 |
| 21 | TX | 45.47 | 0.953 |
| 22 | MgF₂ | 97.25 | 1.330 |
| 23 | TX | 46.59 | 0.976 |
| 24 | MgF₂ | 100.88 | 1.380 |
| 25 | TX | 44.72 | 0.937 |

TABLE 4
Third PBS (λ0 = 405 nm)

| | | Physical Film | |
|---|---|---|---|
| | | Thickness | QWOT |
| Layer No. i | Material | d (nm) | (4 · n · d/λ0) |
| 26 | SiO₂ | 109.77 | 1.590 |
| 27 | TX | 44.20 | 0.926 |
| 28 | MgF₂ | 130.49 | 1.785 |
| 29 | TX | 33.89 | 0.710 |
| 30 | MgF₂ | 119.16 | 1.630 |
| 31 | TX | 25.54 | 0.535 |
| 32 | SiO₂ | 158.79 | 2.300 |
| 33 | TX | 37.42 | 0.784 |
| 34 | MgF₂ | 122.82 | 1.680 |
| 35 | TX | 34.53 | 0.723 |
| 36 | MgF₂ | 125.01 | 1.710 |
| 37 | TX | 30.55 | 0.640 |
| 38 | SiO₂ | 81.46 | 1.180 |
| 39 | TX | 66.70 | 1.398 |
| 40 | MgF₂ | 294.53 | 4.029 |
| 41 | TX | 28.41 | 0.595 |

Adhesive Layer S (Refractive Index: 1.52)
Glass Substrate E (Refractive Index: 1.64)

TABLE 5
Fourth PBS (λ0 = 405 nm)
Glass Substrate M (Refractive Index: 1.64)

| | | Physical Film | |
|---|---|---|---|
| | | Thickness | QWOT |
| Layer No. i | Material | d (nm) | (4 · n · d/λ0) |
| 1 | TX | 88.30 | 1.850 |
| 2 | MgF₂ | 248.56 | 3.400 |
| 3 | TX | 55.37 | 1.160 |
| 4 | SiO₂ | 81.46 | 1.180 |
| 5 | TX | 30.55 | 0.640 |
| 6 | MgF₂ | 125.01 | 1.710 |
| 7 | TX | 40.57 | 0.850 |
| 8 | MgF₂ | 122.82 | 1.680 |
| 9 | TX | 37.42 | 0.784 |
| 10 | SiO₂ | 158.79 | 2.300 |
| 11 | TX | 25.54 | 0.535 |
| 12 | MgF₂ | 119.16 | 1.630 |
| 13 | TX | 33.89 | 0.710 |
| 14 | MgF₂ | 130.49 | 1.785 |
| 15 | TX | 44.20 | 0.926 |
| 16 | SiO₂ | 109.77 | 1.590 |
| 17 | TX | 44.72 | 0.937 |
| 18 | MgF₂ | 100.88 | 1.380 |
| 19 | TX | 46.59 | 0.976 |
| 20 | MgF₂ | 93.57 | 1.280 |
| 21 | TX | 53.46 | 1.120 |
| 22 | SiO₂ | 86.30 | 1.250 |
| 23 | TX | 53.46 | 1.120 |
| 24 | MgF₂ | 95.04 | 1.300 |
| 25 | TX | 52.50 | 1.100 |

TABLE 6
Fourth PBS (λ0 = 405 nm)

| | | Physical Film | |
|---|---|---|---|
| | | Thickness | QWOT |
| Layer No. i | Material | d (nm) | (4 · n · d/λ0) |
| 26 | MgF₂ | 98.69 | 1.350 |
| 27 | TX | 45.34 | 0.950 |
| 28 | SiO₂ | 98.72 | 1.430 |
| 29 | TX | 43.44 | 0.910 |
| 30 | MgF₂ | 73.10 | 1.000 |
| 31 | SiO₂ | 207.11 | 3.000 |
| 32 | TX | 42.96 | 0.900 |
| 33 | MgF₂ | 119.89 | 1.640 |
| 34 | TX | 38.66 | 0.810 |
| 35 | MgF₂ | 122.08 | 1.670 |
| 36 | TX | 38.19 | 0.800 |
| 37 | SiO₂ | 207.11 | 3.000 |
| 38 | MgF₂ | 87.73 | 1.200 |
| 39 | TX | 31.50 | 0.660 |
| 40 | SiO₂ | 124.27 | 1.800 |
| 41 | TX | 52.50 | 1.100 |
| 42 | MgF₂ | 123.55 | 1.690 |
| 43 | TX | 19.09 | 0.400 |
| 44 | MgF₂ | 73.10 | 1.000 |

Adhesive Layer S (Refractive Index: 1.52)
Glass Substrate E (Refractive Index: 1.64)

1. A method of adjusting the phase shift of s-polarized light reflected from a polarization beam splitter film having a multiple-layer construction,
wherein, in a desired range of incidence angles and in a desired range of wavelengths, when reflection-induced phase shift of the s-polarized light is not linear with respect to an incidence angle thereof, layers are arranged in reverse order.

2. A method of adjusting the phase shift as claimed in claim 1,
wherein, in the desired range of incidence angles and in the desired range of wavelengths, if electric field intensity distribution of the s-polarized light as observed from a light-entrance side to a light-exit side exhibits an increase exceeding a predetermined value, electric field intensity of the s-polarized light is reduced down to the predetermined value or less by adjusting a film thickness of a layer in which the electric field intensity distribution of the s-polarized light exhibits the increase.

3. A method of adjusting the phase shift as claimed in claim 2,
wherein a substrate is disposed on the light-entrance side of the polarization beam splitter film, and the predetermined value is four times an electric field intensity as observed in the substrate.

4. A method of adjusting the phase shift as claimed in claim 1,
wherein the desired range of incidence angles is ±5° of a predetermined value, and a deviation of the phase shift from a linear function determined by phase shifts observed at minimum and maximum incidence angles is within ±50° all over the desired range of incidence angles.

5. A method of adjusting the phase shift as claimed in claim 2,
wherein, when polarization separation characteristics obtained are not as desired, a film thickness other than the film thickness that has already been adjusted is adjusted so as to vary the polarization separation characteristics.

6. A polarization beam splitter film having a multiple-layer construction,
wherein, in a desired range of incidence angles and in a desired range of wavelengths,
a reflection-induced phase shift of s-polarized light varies linearly with respect to variation of an incidence angle thereof,
whereas, when the multiple-layer construction has layers thereof arranged in reverse order, the reflection-induced phase shift of the s-polarized light does not vary linearly with respect to the variation of the incidence angle thereof.

7. A polarization beam splitter film as claimed in claim 6,
wherein a substrate is disposed on a light-entrance side of the polarization beam splitter film, and
in the desired range of incidence angles and in the desired range of wavelengths, an electric field intensity of the s-polarized light as observed from the light-entrance side to a light-exit side is less than or equal to four times an electric field intensity as observed in the substrate.

8. A polarization beam splitter film as claimed in claim 6,
wherein the desired range of wavelengths is ±5 nm of a predetermined wavelength.

9. A polarization beam splitter film as claimed in claim 6,
wherein the desired range of incidence angles is from 40° to 50°, both ends inclusive.

10. A polarization beam splitter comprising:
a first substrate that is transparent; and
a polarization beam splitter film formed on the first substrate,
wherein, when light in a desired range of wavelengths is incident on the polarization beam splitter film from a first direction in a desired range of incidence angles, a deviation of a reflection-induced phase shift of s-polarized light from a phase shift curve expressed as a linear function determined by phase shifts observed at minimum and maximum incidence angles is within ±50° all over the desired range of incidence angles, and
when the light is incident on the polarization beam splitter film from a second direction opposite to the first direction, the reflection-induced phase shift of the s-polarized light from the phase shift curve is outside ±50° all over the desired range of incidence angles.

11. A polarization beam splitter as claimed in claim 10,
wherein the desired range of incidence angles is from 40° to 50°, both ends inclusive.

12. A polarization beam splitter as claimed in claim 10,
wherein the desired range of wavelengths is ±5 nm of a predetermined wavelength.

13. A polarization beam splitter as claimed in claim 10, further comprising:
a second substrate that is transparent,
wherein the first and second substrates are bonded together with the polarization beam splitter film sandwiched therebetween.

14. A polarization beam splitter as claimed in claim 10,
wherein, when the light is incident from the first direction, the deviation of the reflection-induced phase shift of the s-polarized light from the phase shift curve is within ±20° all over the desired range of incidence angles.

15. A polarization beam splitter as claimed in claim 10,
wherein, when the light is incident from the first direction, the deviation of the reflection-induced phase shift of the s-polarized light from the phase shift curve is within ±10° all over the desired range of incidence angles.

16. A polarization beam splitter as claimed in claim 10,
wherein, when the light is incident from the first direction, the reflection-induced phase shift of the s-polarized light varies smoothly over the desired range of incidence angles.

17. A polarization beam splitter comprising:
a first substrate that is transparent; and
a polarization beam splitter film formed on the first substrate,
wherein, when light in a desired range of wavelengths is incident on the polarization beam splitter film from a first direction in a desired range of incidence angles, a deviation of a reflection-induced phase shift of s-polarized light from a phase shift curve expressed as a linear function determined by phase shifts observed at minimum and maximum incidence angles is within ±20° all over the desired range of incidence angles, and
when the light is incident on the polarization beam splitter film from a second direction opposite to the first direction, the reflection-induced phase shift of the s-polarized light from the phase shift curve is outside ±20° all over the desired range of incidence angles.

18. A polarization beam splitter as claimed in claim 17,
wherein the desired range of incidence angles is from 40° to 50°, both ends inclusive.

19. A polarization beam splitter as claimed in claim 17,
wherein the desired range of wavelengths is ±5 nm of a predetermined wavelength.

20. A polarization beam splitter as claimed in claim 17, further comprising:
a second substrate that is transparent,
wherein the first and second substrates are bonded together with the polarization beam splitter film sandwiched therebetween.

21. A polarization beam splitter as claimed in claim 17,
wherein, when the light is incident from the first direction, the deviation of the reflection-induced phase shift of the s-polarized light from the phase shift curve is within ±10° all over the desired range of incidence angles.

22. A polarization beam splitter as claimed in claim 17,
wherein, when the light is incident from the first direction, the reflection-induced phase shift of the s-polarized light varies smoothly over the desired range of incidence angles.

23. A polarization beam splitter comprising:
a first substrate that is transparent; and
a polarization beam splitter film formed on the first substrate,
wherein, when light in a desired range of wavelengths is incident on the polarization beam splitter film from a first direction in a desired range of incidence angles, a deviation of a reflection-induced phase shift of s-polarized light from a phase shift curve expressed as a linear function determined by phase shifts observed at minimum and maximum incidence angles is within ±10° all over the desired range of incidence angles, and
when the light is incident on the polarization beam splitter film from a second direction opposite to the first direction, the reflection-induced phase shift of the s-polarized light from the phase shift curve is outside ±10° all over the desired range of incidence angles.

24. A polarization beam splitter as claimed in claim 23,
wherein the desired range of incidence angles is from 40° to 50°, both ends inclusive.

25. A polarization beam splitter as claimed in claim 23,
wherein the desired range of wavelengths is ±5 nm of a predetermined wavelength.

26. A polarization beam splitter as claimed in claim 23, further comprising:
a second substrate that is transparent,
wherein the first and second substrates are bonded together with the polarization beam splitter film sandwiched therebetween.

27. A polarization beam splitter as claimed in claim 23,
wherein, when the light is incident from the second direction, the reflection-induced phase shift of the s-polarized light does not vary smoothly over the desired range of incidence angles.
